(19) United States
(12) Patent Application Publication
(10) Pub. No.: US 2023/0398474 A1
(43) Pub. Date: Dec. 14, 2023

(54) FILTER UNIT, TEXTILE TREATMENT APPARATUS AND METHOD

(71) Applicant: Xeros Limited, Rotherham, South Yorkshire (GB)

(72) Inventors: Joseph Michael MATTLEY, Rotherham, South Yorkshire (GB); Thomas Andrew COBB, Rotherham, South Yorkshire (GB); Paul Fredrik Lars SERVIN, Rotherham, South Yorkshire (GB); Elliot William BLAND, Rotherham, South Yorkshire (GB)

(21) Appl. No.: 18/035,442

(22) PCT Filed: Nov. 4, 2021
(86) PCT No.: PCT/GB2021/052855

§ 371 Date: May 4, 2023

(30) Foreign Application Priority Data
Nov. 4, 2020 (GB) GB2017478.5
Sep. 17, 2021 (GB) GB2113287.3

(51) Int. Cl. B01D 33/11; B01D 33/56; B01D 29/90; C02F 1/00; D06F 39/10

(52) U.S. Cl. CPC B01D 33/11; B01D 33/56; B01D 29/90; C02F 1/001; D06F 39/10; B01D 2201/0423; B01D 2201/18; B01D 2201/301; C02F 2101/34

(57) ABSTRACT

The present invention relates to a filter unit suitable for filtering microfibres within a feed, especially a feed originating from a textile treatment apparatus. The present invention also relates to a textile treatment apparatus comprising said filter unit and a method of filtering utilising said filter unit.

### FIELD OF THE INVENTION

The present disclosure relates to a filter unit suitable for filtering microfibres within a feed, especially a feed originating from a textile treatment apparatus. The present disclosure also relates to a textile treatment apparatus comprising said filter unit and a method of filtering utilising said filter unit.

### BACKGROUND

It has been calculated that the global release of microfibres into the Earth's oceans is around 500,000 tonnes per year. Textile treatments and garment washing produce significant amounts of microfibres which are conventionally simply allowed to exit via the effluent. So as an example, it has been determined that a 6 Kg wash load can release around 700,000 fibres per wash. Microfibres have been detected across the entire trophic range, in plankton, in fish and estimates indicate that Europeans eat up to 11,000 pieces of plastic per year. Microplastics more generally have been detected in rivers, seas, lakes, oceans, ice samples and falling snow across the globe.

Filters for partially or completely removing microfibres are known. PCT patent publication WO2019/122862 discloses a centrifugal filter which is especially effective at filtering microfibres from the effluent originating from washing machines.

In view of the above the present inventors sought to make further improvements regarding one or more of the following technical problems:
i. To reduce the tendency of the filter unit to block with microfibres,
ii. To provide a filter unit which is able to filter the feed from many textile treatment cycles with a reduced necessity for user intervention to clean or replace the filter media,
iii. To attempt to retain or improve the efficiency of the filtering of the microfibres,
iv. To filter difficult microfibres such as those which are or comprise natural fibres and especially which are or comprise cellulosics,
v. To provide a filter unit which can be compact in size and/or which is able to provide a good flow rate for a relatively small filter unit capacity.

Whilst attempting to make improvements regarding the above technical problems the present inventors became aware that several of these are in conflict. So, by way of example the inventors chose to increase the pore size of the filter media within the filter unit so as to reduce the tendency of the filter unit to block but this has the undesirable concomitant effect of reducing the filtration efficiency. This occurs because many of the much smaller microfibres now pass through the larger pores. In this way the present inventors came to appreciate that it is particularly difficult to simultaneously improve combinations of the above technical problems.

In particular, the present inventors found that attempting to make improvements in any one or more of technical problems iii, iv and v tended to adversely affect the outcomes for the desired improvements in technical problems i. and ii. Thus, the present inventors sought, in particular, to find technical solutions which addressed these technical problems in combination.

The Invention

According to a first aspect of the present invention there is provided a filter unit suitable for filtering microfibres within a feed, the filter unit comprising:
a) a housing;
b) an inlet configured to allow the feed to enter the housing;
c) an outlet configured to allow a filtered feed to exit the housing;
d) a filter cage supporting one or more filter media, the filter cage being rotatably mounted and rotating about an axis of rotation within the housing, the filter media having pores with a mean pore size of no more than 100 microns;
e) one or more baffle surfaces being located adjacent to at least a portion of the interior and/or exterior surfaces of the one or more filter media;
the baffle surfaces and filter cage being configured such that during rotation of the filter cage, the one or more filter media move relative to the one or more baffle surfaces and turbulent flow of liquid when present in the filter unit is encouraged near the interior and/or exterior surface of the one or more filter media;
f) a drive means for rotating the filter cage;
g) the filter unit being configured such that feed from the inlet is directed towards the interior of the filter cage, the feed then passes through the one or more filter media and exits as a filtered liquid via the outlet.

Microfibres

The word microfibres as used herein preferably means microfibres having a longest linear dimension of less than 1 mm. Preferably, in order of increasing preference microfibres have a longest linear dimension of no more than 500 microns, no more than 250 microns, no more than 200 microns, no more than 150 microns and no more than 100 microns.

The word microfibres can additionally or alternatively mean fibres having a diameter of less than ten micrometers.

The longest linear dimension and the diameter can be measured by optical or electron microscopy with suitable image analysis software. Preferably the longest linear dimension and/or the diameter of the microfibre is a mean. The mean is preferably an arithmetic mean. The arithmetic mean is preferably established from measuring at least 100, more preferably at least 1,000 and especially at least 10,000 microfibres.

Microfibres can be or comprise a synthetic material, a semi-synthetic material or a natural material or a blend thereof. Synthetics such as polyamides, polyesters, acrylics are easier to filter whilst the present inventors have found that fibres which are or comprise natural materials (e.g. wool, cotton, silk) and especially which are or comprise cellulosic materials are much more difficult to filter. The key difficulty is the tendency of cellulosic materials noted by the present inventors to block the pores in the filter media. Whilst not wishing to be limited by any theory it is believed that cellulosic fibres tend to form films on the surface of filter media which can rapidly lead to blockage of the filter as a whole.

Feed

Preferably, the feed is a fluid. Preferably, the feed is not in the form of a paste or semi-solid. The feed is preferably a liquid and especially an aqueous liquid. When the feed comprises liquids other than water these may be alcohols, ketones, ethers, cyclic amides and the like. Preferably, the liquid comprises at least 50 wt %, more preferably at least 80 wt % and most especially at least 90 wt % of water.

In some embodiments, the feed comprising microfibres originates from a textile treatment apparatus.

Optionally, the feed is an effluent feed. By the words “effluent feed” we preferably mean it that can originate from the effluent from a cycle of textile treatment apparatus e.g. a wash cycle.

Alternatively, the feed is a polishing feed. By the words “polishing feed” we preferably mean the liquids present in the textile treatment apparatus during some portion of the textile treatment cycle. Typically, the polishing feed is recycled between the filter unit and the textile treatment apparatus.

Housing

Preferably the housing comprises one or more housing walls. These housing walls preferably form the exterior of the filter unit. Preferably, the housing envelops or surrounds the filter cage and provides the means to support and mount the filter cage. Preferably, the drive means can be mounted onto or into the housing. The housing can be made of any suitable material including plastic, metal or alloy, ceramic, wood or any other similar and suitably rigid material.

The housing can be or comprise of any suitable shape including cuboid, prismatic, spherical, conical but it preferably is or comprises a cylinder or something approximating to cylinder such as a regular polygon based prism wherein the polygon has a number of sides of 6 or more, e.g. 6 to 20 sides. When the housing is or comprises a cylinder or something approximating to a cylinder it preferably has one or more side walls, a first end wall and a second end wall.

The housing walls can comprise one or more priming openings in addition to the inlet and outlet. Such openings can assist in priming of the filter unit and removal of air from the filter unit as the feed enters the inlet. Such priming openings can be always open or they can be opened and closed by way of a priming valve located in fluidic communication with the priming opening.

In some embodiments the housing walls and the filter unit as a whole are air-tight. Typically, in operation no air can enter or exit the filter unit unless it does so via an inlet, outlet or a priming opening if present.

The filter unit can be open to the air for example when the filter unit is vertically mounted with respect to gravity and the filter cage rotates so that the axis of rotation is substantially vertical. In such an embodiment the housing can have on or more air holes typically in a region of the housing above the uppermost part of the filter cage.

In some embodiments the housing walls and the filter unit as a whole are liquid-tight. Typically, in operation liquid (e.g. water) can only enter or exit the filter via an inlet or outlet.

Lid

Optionally the filter unit can comprise a lid. The lid is preferably openable or removable with respect to the filter unit. The lid is typically located in the housing and more typically where the housing is in the form of a cylinder or something approximating to a cylinder the lid is on one of the end faces. The lid is preferably sealed when in the closed position or when installed with respect to the housing. The seal is preferably air-tight and/or liquid-tight. The lid when open or removed preferably permits the user to access the filter cage. Thus, the user can easily remove the filter cage and/or the filter media so as to clean or replace these components.

In some alternative embodiments the housing may comprise an opening and a moveable lid that is movable between a first configuration and a second configuration. In the first configuration the lid cooperates with the housing to seal the opening so entry of the effluent into the housing is through the inlet only and exit of the filtered effluent from the housing may be through the outlet only. In the second configuration the lid may be moved to a position to expose the opening in the housing so that filtride accumulated on the filter media can be removed from the housing through the opening. The opening may be annular, circular or square in shape when the lid is in the second configuration. The moveable lid may be shaped as a frustrum, a cone, a cylinder, or a pyramid, amongst others. The movable lid may move linearly between the first and second configurations. Optionally the lid may move linearly in the horizontal direction. The filter unit may comprise an actuator to move the moveable lid. The actuator may be a linear actuator amongst others. Inlet

The inlet permits feed to enter the housing. The inlet may be in the form of an aperture, more preferably the inlet is in the form of a pipe emanating from the housing. The inlet can be located on the housing wall(s). The filter unit may comprise a plurality of inlets. In some alternative embodiments, the pipe may extend from external to the housing to the aperture in the wall of the housing. The pipe may also pass through the aperture and extend internally within the housing. The pipe may also extend though at least part of the filter cage. In a particularly preferred embodiment, the pipe passes from the exterior of the housing, through the aperture to the interior of the filter cage, optionally the pipe may deliver feed to an external surface of the one or more filter media. Thus, the filter unit may comprise a pipe, the pipe and may be configured such that feed from the inlet passes through the interior of the filter cage via the pipe. The filter unit may be configured such that feed exits from the pipe and passes through the exterior surface of the one or more filter media where it then exits as a filtered liquid from the interior surface.

The filter is configured such that feed from the inlet is directed towards the interior of the filter cage. Thus, typically the inlet is located in the housing proximate to an opening to the interior of the filter cage. In some alternative embodiments, feed may be directed to the interior of the filter cage, where it then leaves the filter cage, then passes through the one or more filter media. In some embodiments, feed may pass through the filter cage segregated from the one or more filter media. Segregation may be by the walls of the pipe as discussed above.

If the filter unit is not air-tight then the filter unit is typically used in a vertical arrangement and the inlet will typically be located in the housing towards or at the highest point of the filter unit.

The inlet is typically aligned with a plane parallel to an axis of rotation of the filter cage.

Outlet

The outlet permits filtered feed to exit the housing.

The outlet may be in the form of an aperture, more preferably the outlet is in the form of a pipe emanating from the housing. The outlet can be located on the housing wall(s). The filter unit may comprise a plurality of outlets.

The outlet is typically located in the housing proximate the areas where the filtered feed has passed through the filter media.

When the filter unit is not air-tight and the filter unit is typically used in a vertical arrangement and the outlet will typically be located in the housing towards or at the lowest point of the filter unit.

The outlet is typically aligned with a plane perpendicular to an axis of rotation of the filter cage. Typically, the outlet is tangential to the outer periphery of the housing.

Filter Cage

The filter cage supports the one or more filter media. The filter cage is preferably rigid. Preferably, the filter cage permits the one or more filter media to be rotated and in particular to be rotated without the filter media becoming significantly distorted or bent by the centrifugal forces experienced during rotation. The filter cage may be unitary with the one or more filter media or they can be separate. The filter cage can comprise one of more filter cage fixings or filter cage location components to assist in fixing or locating the one or more filter media to the filter cage.

The filter cage preferably has one end which is open. Preferably the open end of the filter cage is proximate to the inlet and aligned such that feed from the inlet enters the filter cage.

The filter cage may be in the form of a cylinder or something approximating to cylinder such as a regular polygon-based prism wherein the polygon has a number of sides of 6 or more, e.g. 6 to 20 sides. The one or more filter media are preferably located along the side walls of the of the filter cage. Preferably, the filter cage is cylindrical.

In some alternative embodiments, the filter cage is, comprises or approximates to a frustrum of a cone, a cone, a pyramid, a prism or a hemisphere in shape. The filter cage may support one or more filter media so that it is retained in any of the aforementioned shapes.

Preferably, the filter cage has one closed end typically where no filter media are located and more typically where the filter cage connects to the drive means.

Preferably, one of the end walls of the cylinder or something approximating to a cylinder is open. Preferably, the filter cage forms a drum with one open end and one closed end.

Typically, the open end permits the feed to be directed towards the interior of the filter cage.

Typically, the closed end of the filter cage is in the shape of a circular disc.

The filter cage can be made of any suitable material including plastic, metal or alloy, ceramic, wood or any other similar and suitably rigid material.

Filter Media

The number of filter media present in the filter unit is preferably no more than 100, more preferably no more than 50, especially no more than 20 and most especially no more than 10.

Preferred numbers of filter media include 1, 2, 3, 4, 6 and 8.

The one or more filter media can be in the form of a non-woven mesh, a woven mesh, a knitted mesh or more preferably a perforated sheet.

In order of increasing preference, the pores in the one or more filter media have a mean pore size of no more than 90 microns, no more than 80 microns, no more than 70 microns, no more than 60 microns. Such particularly small pore sizes have been found to provide excellent efficiency in the removal of microfibres whilst simultaneously still not blocking too readily because of the presence of the one or more baffle surfaces.

In order of increasing preference, the pores in the one or more filter media have a mean pore size of at least 0.1 microns, at least 0.5 microns, at least 1 micron, at least 2 microns, at least 5 microns and at least 10 microns.

The mean pore size is preferably the arithmetic mean pore size. The pore size is preferably the largest linear size of the pore. In the case of a circular pore this would be a diameter. In the case of a pore taking the form of a slot this would be the length of the slot.

The mean is preferably established by optical or electron microscopy using suitable image analysis software.

The mean is preferably the mean of at least 100, more preferably at least 1,000 and especially at least 10,000 pores.

The filter media may be planar in shape, more preferably the one or more filter media are curved in shape, especially the one or more filter media are curved such that they adopt substantially the same shape as the side walls of the preferred cylindrical filter cage.

The one or more filter media may be curved or otherwise arranged in a three-dimensional shape. Possible three-dimensional shapes of the one or more filter media may include a cylinder, a cone, a frustrum of a cone, a pyramid, a prism or a hemisphere. Preferably the one or more filter media are conical in shape, in particular, frusto-conical in shape.

When one filter medium is present in the filter cage, the filter medium preferably is cylindrical or frusto-conical in shape. When a plurality of filter media are present in the filter cage, the filter media preferably in combination act so as to form a cylindrical or frustro-conical shape when arranged in the filter cage. Alternatively, one filter medium or more than one filter media may be in the shape of a paraboloid, hemisphere, hemi-ellipsoid, pyramid, cone, frustrum, cylinder, or prism.

The filter media can be made of any suitable material including plastic, metal or alloy, ceramic, or any other suitable material for preparing filter media.

Preferably, the one or more filter media are positioned and oriented in the filer cage such that they form a cylinder, a cone or frustum which has a central axis which is common with axis of rotation of the filter cage and the one or more filter media. This allows each of the one or more filter media to act substantially the same with regard to filtration of the feed and it assists in balancing the filter cage during rotation.

The one or more filter media may be arranged around the axis of rotation of the filter cage and optionally may be arranged rotationally symmetric around the axis of rotation. Thus the one or more filter media may at least partially define an enclosed a volume around the axis of rotation. The inlet may be arranged to provide feed to the volume at least partially enclosed by the one or more filter media. Filtride may be filtered from the feed by passing radially outwards through the one or more filter media. Thus, filtride may be deposited on the interior surface of the one or more filter media and filtered feed may pass out of the exterior surface of the filter media.

Rotatably Mounted

The filter cage is rotatably mounted within the housing. The filter cage preferably rotates about an axis of rotation. The filter cage is preferably rotationally symmetrical and is especially preferably balanced with respect to rotation. By balanced with respect to rotation it is preferably meant that the filter cage will not tend to shake or vibrate unduly when rotated e.g. when rotated at 100 rpm or 1500 rpm or 3000 rpm.

Preferably the filter cage comprises a drive connector for connecting the drive means to the filter cage. Optionally, this can be in the form of a mating surface especially where the drive means comprises a spline to engage a mating surface on the filter cage. Optionally, the drive connector may be in the form of gears or a belt and pulley system or other known mechanical systems for transferring rotational movement

When the housing is or comprises a cylinder, frustrum of a cone or other three-dimensional shape or something approximating to cylinder as hereinbefore described it is preferred that the filter cage is able to rotate about an axis which is aligned to the side walls of the housing and which is more preferably substantially central within the housing when viewed from directly above the axis of rotation.

Preferably, the housing side walls and the filter cage are concentric when viewed from directly above the axis of rotation.

In some alternative embodiments where the filter unit comprises a moveable lid and an opening, the filter cage may be rotatable to throw filtride off the filter media through the opening when the moveable lid is in the second configuration. The filter unit may comprise a drive means configured to rotate the filter media to throw filtride (i.e. filter residue) off the exterior surface filter media. The drive means may be configured to provide sufficient rotational speed to throw filtride off the filter media with centrifugal force. The drive means may be capable of rotating the filter media at a G force at the radially outermost part of the filter medium of at least 2 G, or at least 5 G, or at least 20 G, or at least 40 G, or at least 100 G or at least 175 G, or at least 250 G or at least 325 G or at least 450 G. The number of revolutions per minute of the filter medium optionally may not exceed 10,000 G, or 2000 G, or 1000 G, or 500 G at the radially outermost part of the filter. In some embodiments, the filter medium may have a number of revolutions per minute when undergoing high speed rotation of at least 100, or at least 800, or at least 1000 or at least 1200 or at least 1400 or at least 1800 or at least 2000. The number of revolutions per minute of the filter medium optionally may not exceed 10,000, or 5000, or 2500, or 2100.

In some alternative embodiments where the filter unit comprises a moveable lid and an opening, the filter unit may comprise a container for receiving filtride that is external to the housing. The filtride received by the container may be filtride thrown through the opening by rotation of the one or more filter medium. The container may be adjacent to and radially outwards of the opening when the lid is in the second configuration. The container may be annular and may extend around the opening. The container may be detachable or may comprise a detachable portion, which may facilitate emptying of the container.

Baffle Surfaces

Preferably, the one or more baffle surfaces have one or more waves. Preferably, most and more preferably all of the baffle surfaces present have one or more waves.

When not rotating, the one or more filter media and the cage will effectively be in a static position. In this static position when viewed down the axis of rotation the one or more baffle surfaces or waves preferably vary in distance from the nearest one or more filter media when measured in any radial direction as the frame of reference for taking the distance is rotated around the axis of rotation of the filter cage and one or more filter media.

Preferably, the distance between a fixed point on the one or more filter media extending towards the nearest one or more baffle surfaces or waves along a radial direction varies in distance as the one or more filter media and the filter cage are rotated.

Preferably, the one or more baffle surfaces or waves may project radially inwards towards the one or more filter media from the housing.

Preferably each wave has an amplitude, more preferably all the waves have substantially or approximately the same amplitude. The amplitude being measured from the lowest to the highest point of each wave.

Whilst not wishing to be limited by any theory, the present inventors discovered that baffle surfaces having one or more waves surprisingly provided a better simultaneous balance of properties and so better solved the abovementioned technical problems when considered in combination.

The one or more baffle surfaces can have a wave with a shape which never repeats.

Preferably, the one or more baffle surfaces have a wave with a shape which repeats.

The number of waves can be 1, 2, 3, 4, 5, 6, 7, 8, 9 or 10.

The number of waves can be no more than 1,000, no more than 500, no more than 200, no more than 100, no more than 50, no more than 30 or no more than 20.

These waves can be present on a single baffle surface or they can be distributed over all of the baffle surfaces present in the filter unit.

When more than one baffle surface is present in the filter unit the baffle surfaces are optionally spaced substantially equidistantly from each other. Thus, when two baffle surfaces are present these are typically spaced apart at an angle of separation of 180 degrees when measured about the axis of rotation of the filter cage and in a plane perpendicular to said axis. More generally speaking with a number of baffle surfaces (N) the angle of separation (as measured above) is preferably given by 360/N where N is an integer.

The present inventors have found that a single wave works particularly effectively.

Preferably, the shape of the wave is or comprises a square wave, arc wave, sine wave, triangular wave or a combination thereof. Preferably, the shape of the wave is an arc wave or a saw tooth wave. An arc wave can comprise an arc so examples include a semi-circle, a crescent, a sharks fin or a similar shape. Preferably, all of the waves are of substantially the same shape and substantially the same dimensions. Preferably, all of the waves are oriented in the same way with respect to either of the directions of rotation.

In some embodiments, the one or more waves curve around a portion or a whole of a cylindrical surface. In this manner the baffle surface preferably conforms to the interior of the housing when that is also a cylinder.

In some alternative embodiments, the baffle surfaces may be adjacent to at least a portion of the interior surface of the one or more filter media. The one or more baffle surfaces may be connected to the housing and may remain static during rotation of the filter cage.

Optionally, the shape of the wave has an abrupt change in gradient in at least one point. Thus, by example preferred waves have at least one vertex.

Preferably, the amplitude of the waves is measured in a radial direction.

In order of increasing preference, the amplitude of the waves is at least 0.1 mm, at least 0.5 mm, at least 1 mm, at least 2 mm, at least 3 mm, at least 4 mm and at least 5 mm.

In order of increasing preference, the amplitude of the waves is no more than 100 mm, no more than 70 mm, no more than 50 mm and no more than 40 mm.

The abovementioned one or more waves on the one or more baffles provide a variation in the distance from any point on the baffle surface to the filter media, preferably when measured along any radial direction towards the axis of rotation of the filter cage. This variation in the distance is preferably present or perceivable as the filter cage and the filter media rotate. It is most easily apparent by viewing the varied gaps as between the one or more baffle surfaces and the one or more filter media from along the axis of rotation,

The abovementioned one or more waves on the one or more baffles provide a nearest distance from any point on the baffle surface to the filter media, preferably when measured along any radial direction towards the axis of rotation of the filter cage.

Preferably, the distance between the one or more filter media and the one or more surfaces of the baffle measured in a radial direction varies as the one or more filter media are rotated along with the filter cage during operation of the filter unit.

In order of increasing preference, the variation in the distance is at least 5%, at least 10%, at least 20%, at least 30%, at least 40% and at least 50% of the furthest distance.

In order of increasing preference, the variation in the distance is no more than 99%, no more than 95%, no more than 90%, no more than 80%, no more than 75% and no more than 70% of the furthest distance.

The furthest and nearest distance mentioned above are preferably measured to the closest of the interior or exterior surface of the one or more filter media. Thus, if the baffle surface is located adjacent to the exterior surface of the one or more filter media the furthest distance is that furthest one as measured from any point on the baffle surface to the exterior of the filter media when measured along any radial direction towards the axis of rotation of the filter cage. The exterior being the side on which the feed has now been filtered. Equally, if the baffle surface is located adjacent to the interior surface of the one or more filter media the furthest distance is that furthest one measured from any point on the baffle surface to the interior of the filter media when measured along any radial direction towards the axis of rotation of the filter cage. The interior being the side on which the feed has not yet passed through the filter media and where the feed still comprises microfibres.

Byway of an example if the baffle surface is located adjacent to the exterior surface of the filter media, the baffle surfaces have a shape which is a saw tooth having an height of 5 mm as measured from the lowest to the highest point in the teeth and the highest point in the teeth is spaced 3 mm from the exterior surface of the filter media then the furthest distance is 8 mm (5 mm plus 3 mm). The variation in distance is 62.5% when expressed as a percentage of the furthest distance.

The variation in distance is in order of increasing preference at least 0.1 mm, at least 0.5 mm, at least 1 mm, at least 2 mm, at least 3 mm and at least 5 mm.

The variation in distance is preferably no more than 50 mm, no more than 40 mm, no more than 30 mm and no more than 20 mm.

In order of increasing preference the nearest distance is no more than 500 mm, no more than 300 mm, no more than 200 mm, no more than 100 mm, no more than 50 mm, no more than 40 mm, no more than 30 mm, no more than 20 mm, no more than 10 mm and no more than 5 mm.

In order of increasing preference, the nearest distance is no less than 0.01 mm, no less than 0.05 mm, no less than 0.1 mm and no less than 0.5 mm.

Preferably, the one or more baffle surfaces do not contact any part of the one or more filter media during rotation. Such separation is preferably to prevent premature wear of the filter media, and may reduce fluid friction resisting rotation of the filter cage.

The baffle surfaces may be continuous through an angle of 360 degrees.

More preferably, at least some and especially all of the baffle surfaces are not continuous through an angle of 360 degrees. Whilst not wishing to be limited by any theory, the present inventors discovered that non-continuous baffle surfaces surprisingly provided a better simultaneous balance of properties and so better solved the abovementioned technical problems when considered in combination.

In order of increasing preference, at least one baffle surface is continuous through an angle of at least 5 degrees, at least 10 degrees, at least 20 degrees, at least 30 degrees, at least 40 degrees, at least 45 degrees, at least 50 degrees, at least 60 degrees, at least 70 degrees, at least 80 degrees and at least 90 degrees.

In order of increasing preference, at least one baffle surface is continuous though an angle of no more than 350 degrees, no more than 330 degrees, no more than 300 degrees, no more than 270 degrees, no more than 240 degrees, no more than 210 degrees and no more than 180 degrees.

The abovementioned angle is the angle around the axis of rotation of the filter cage. Accordingly, an angle of 180 degrees can be considered to equate to a baffle surface which is continuous through half of the full rotation of the filter cage. The angle is preferably measured in a plane perpendicular to the axis of rotation of the filter cage.

Preferably, the baffle surface(s) do not cover the entire axial length of the one or more filter media. By the term axial length we preferably mean the length of the filter media when measured in a direction parallel to the axis of rotation of the filter cage.

Whilst not wishing to be limited by any theory, the present inventors discovered that baffle surfaces which do not cover the entire axial length of the one or more filter media surprisingly provided an even better simultaneous balance of properties and so even better solved the abovementioned technical problems when considered in combination.

Put another way preferably some portions of filter media in some parts of their axial length do not have a baffle surface which is adjacent.

In order of increasing preference, the baffle surface(s) covers no more than 90%, no more than 80%, no more than 70%, no more than 60% and no more than 50% of the axial length of the one or more filter media.

Thus, byway of an example if the axial length of the one or more filter media is 10 mm and the baffle surface(s) cover 7 mm of the one or more filter media as measured in a direction parallel to the axis of rotation of the filter cage then the baffle surface(s) cover 7/10×100 i.e. 70% of the axial length of the one or more filter media.

In order of increasing preference, the baffle surface(s) do not cover at least 1 mm, at least 2 mm, at least 3 mm, at least 5 mm, at least 10 mm or at least 20 mm in length along the axial direction of the one or more filter media. The remaining portion of the one or more filter media is, of course, preferably covered by an adjacent baffle surface.

In order of increasing preference, the baffle surface(s) do cover at least 1 mm, at least 2 mm, at least 3 mm, at least 5 mm, at least 10 mm or at least 20 mm in length along the axial direction of the one or more filter media.

The one or more baffle surfaces may be inclined relative to the axis of rotation. Where the filter media is inclined relative to the axis of rotation, the one or more baffle surfaces may also be inclined with the same inclination angle. Thus, the one or more baffle surfaces may be parallel to the filter media and optionally both the one or more baffle surfaces and the filter media are inclined relative to the axis of rotation.

The one or more baffle surfaces may themselves be rotatable, which is optionally rotatable about the same axis of rotation of the filter cage. The direction of rotation of the baffles can be the same as that of the filter cage or opposite to that of the filter cage.

Preferably, the one or more baffle surfaces are static, more preferably all of the baffle surfaces are static.

Preferably, the baffle surfaces are prevented from moving by the internal surface of the housing.

Preferably, the one or more baffle surfaces are located either radially outward from or radially inward from the one or more filter media.

The baffle surface may be located adjacent to the opposite surface of the one or more filter media to which filtride accumulates as it is filtered from the feed. Preferably, the baffle surface is located adjacent to the exterior surface of the one or more filter media and the feed is supplied to the interior surface of the one or more filter media. In such an arrangement, a portion of the filtered feed liquid rotating between the housing and the filter cage may be diverted by the one or more baffle surface (via turbulence) radially inwards and back through the one or more filter media to disrupt filtride accumulated on the interior surface of the one or more filter media.

Preferably, the filter unit comprises at least one baffle surface being located adjacent to the exterior surfaces of the one or more filter media. Preferably, in the first aspect of the invention e) is one or more baffle surfaces being located adjacent to the exterior surfaces of the one or more filter media. In such an arrangement the turbulent flow of liquid when present in the filter unit is encouraged near the exterior surface of the one or more filter media. Such an arrangement provides best results and/or renders the filter more easily cleanable.

When e) is one or more baffle surfaces being located adjacent to the exterior surfaces of the one or more filter media then the one of more baffle surfaces are preferably located radially outwards from the outer surface of the one or more filter media.

When e) is one or more baffle surfaces being located adjacent to the interior surfaces of the one or more filter media then the one of more baffle surfaces are preferably located radially inwards from the inner surface of the one or more filter media.

Preferably, the filter unit has no baffle surfaces being located adjacent to the interior surfaces of the one or more filter media.

Preferably, the filter unit has no structure which is interposed between the baffle surface and the interior or exterior (as appropriate) surface of the filter media.

The filter media may comprise a first surface. The first surface may be considered to be the surface of the filter media that first contacts the unfiltered feed liquid, i.e. the surface on which filtride accumulates during filtration. The filter media may comprise a second surface. The second surface may be considered the surface of the filter media from which filtered feed passes during filtration, i.e. the opposite surface to the first surface.

The exterior surface or the interior surface of the filter media may be the first surface of the filter media. In some alternative embodiments, preferably the exterior surface of the filter media is the first surface and the interior surface of the filter media the second surface. In some alternative embodiments of the invention the at least one baffle surface may be adjacent to the second surface of the one or more filter media.

Baffle Surface Construction

The one or more baffle surfaces may be made of glass, plastic, metal, alloy, ceramic, rubber or any suitably rigid material.

The one or more baffle surfaces can be formed by moulding, chemical etching, ablation, 3D printing, cutting, grinding along with other similar techniques suitable for forming and shaping surfaces.

The one or more baffle surfaces may be integral with the inner surface of the housing.

Optionally, the one or more baffle surfaces can be located on one or more baffles.

The one or more baffles are optionally removable from the filter unit.

Optionally, the baffle comprises a baffle support. The baffle support optionally takes the form of an insert which can be inserted into the interior of the housing. The baffle support is optionally in the form of a cylindrical ring optionally with cut out portions. The baffle support may have one or more surface which mate with one or more surfaces in the housing thereby locating and/or locking the baffle support into place. Such locating and locking aids in placing the baffle surface in the correct orientation and placing with respect to the filter cage and filter media and/or it assist in ensuring that the baffle surface remains static even whilst the filter cage is rotated at high speed. Optionally, the baffle support largely conforms in shape to the internal shape of the filter unit housing such that the housing and the baffle support form a tight fit.

In some alternative embodiments, the baffle may connect to the housing via a baffle support. In such embodiments, the baffle support may be a rigid member that connects to or is integrally formed with the housing. The baffle support may remain static during operation of the filter unit. The baffle support may be connected to or integrally formed with any other static component within the filter housing. The baffle support may extend radially inwards from the housing. Optionally the baffle support may also extend parallel to the axial direction. The baffle support may retain the baffle surface in a position adjacent to the one or more filter media.

Optionally, the baffle support is on the form of a ring which surrounds the exterior surface of the one or more filter media. Optionally, the baffle support in the form of a ring has one or more baffle surfaces or waves which effectively vary the proximity of the baffle surface to the one or more filter media as the filter media rotate during rotation of the filter cage and operation of the filter unit.

Drive Means

The drive means preferably is or comprises a motor, more especially an electric motor. The drive means can be connected to the filter cage via a shaft which optionally has a filter cage connector for connecting the shaft to the filter cage. Optionally, the filter cage connector on the shaft can be in the form of a spline especially where the filter cage comprises a mating surface to engage the spline. The drive means, the shaft and the filter cage can be aligned through the axis of rotation of the filter cage. The drive means may additionally or alternatively drive the filter cage by means of cogs, gears, belts, clutches or combinations thereof.

The drive means is preferably capable of rotating the filter cage at speeds of at least 100 rpm, at least 200 rpm, at least 500 rpm and at least 1,000 rpm.

The drive means is preferably capable of rotating the filter cage at speeds of no more than 100,000 rpm, no more than 50,000 rpm, no more than 20,000 rpm and no more than 10,000 rpm.

Configuration and Flow Paths

The filter unit is configured such that feed from the inlet is directed towards the interior of the filter cage. The direction of the feed towards the interior of the filter cage can be achieved by means of flow paths, by means of apertures or nozzles which aim the feed in the desired direction or by means of locating the filter cage and the inlet with respect to gravity such that gravity itself tends to direct the feed in the desired direction.

The feed must pass through the one or more filter media. Put another way all of the feed entering the inlet must pass through the filter media before it is able to exit as a filter liquid via the outlet. In this way, the efficiency of the filter unit at removing microfibres is desirably high. This distinction starkly contrasts filtration systems which operate utilising a cross-flow system. Cross-flow systems produce liquid waste streams which are relatively rich in unfiltered microparticles.

This is undesirable since such liquid waste, if put to effluent, would still effectively emit microparticulate material such as microfibres into the environment. The present invention circumvents this difficulty in that the filtered liquid feed exiting the outlet is completely filtered. Put another way all of the feed which exits the outlet has been filtered.

The feed exits as a filtered liquid via the outlet.

Impeller

The filter unit can optionally comprise an impeller. When present the impeller is typically located with the filter cage. The impeller can comprise from 1 to 10, more preferably from 3 to 8 and especially 4, 5 or 6 blades. The impeller can assist the flow of the feed through the filter unit and/or assist in urging the feed through the filter media.

In some embodiments, the filter unit may comprise one or more impellers. One or more impellers may be located in the housing, and optionally external to the filter cage. The one or more impellers may be upstream and/or downstream of the filter media. Downstream of the filter media may refer to any part of the filter unit where filtered effluent from the filter medium passes when in use. Upstream of the filter media may refer to a part of the filter unit where unfiltered effluent passes before reaching the filter medium.

The one or more impellers may be configured to rotate with any of the filter cage, filter media and pipe where present. The one or more impellers may share an axis of rotation with the one or more filter media. Where the filter unit comprises an impeller downstream of the filter unit, and a pipe, the pipe may pass through the centre of the impeller, which may be coincident with the axis of rotation of the impeller and/or filter media.

Filtride

Filtride refers to the filtered material captured by the filter unit of the first aspect of the present invention.

In some embodiments the filtride collects within the filter cage during the operation of the filter unit. In such embodiments substantially all, more typically all, of the filtride collected by the filter unit is retained within the filter cage.

In some embodiments the filtride collects on the one or more filter media. In such an embodiment the orientation of the filter media with respect to the rotation of the filter cage and filter media is such that filtride tends to collect on the innermost surface of the one or more filter media. By innermost here we preferably mean closest to the axis of rotation.

In one embodiment the feed flows through the one or more filter media in a path which is assisted or partially assisted by the centrifugal forces generated by rotation of the filter cage and one or more filter media.

To assist in the filtride being retained on the filter media during rotation it is preferable that the one or more filter media are oriented either parallel to the axis of rotation or no more than 45 degrees, no more than 30 degrees, no more than 20 degrees and more typically no more than 10 degrees from being parallel to the axis of rotation in either direction (e.g. the filter media pointing inwards or pointing outwards relative to the axis of rotation).

Textile Treatment Apparatus

According to a second aspect of the present invention there is provided a textile treatment apparatus comprising a filter unit according to the first aspect of the present invention or a textile treatment apparatus and filter unit according to the first aspect of the present invention where the filter unit is connected to textile treatment apparatus to receive feed therefrom.

The textile treatment apparatus can be of any kind without limitation provided it is configured to treat textile substrates, preferably in the presence of a liquid.

Suitable textile treatment apparatus include dyeing machines, stonewashing machines, finishing machines and especially washing machines.

The textile treatment apparatus preferably comprises a drum which is rotatably mounted so as to be able to rotate liquid and one or more textile substrates. The textile treatment apparatus preferably comprises a tub, said tub preferably surrounding the drum. The textile treatment apparatus preferably comprises a frame.

The textile treatment apparatus preferably comprises a drive means, more preferably an electric motor to rotate the drum.

More preferably the textile treatment apparatus comprises:
a frame;
a drum which is rotatably mounted in the frame;
a tub which surrounds the drum;
a storage compartment for storing solid particles.
a dispensing means for transporting the solid particles from the storage compartment to the drum;
a collecting means for transporting the solid particles from the drum to the storage compartment.

The frame provides a stable structure on which the other components of the textile treatment apparatus can be mounted. Optionally, the frame is enclosed by panels and a door.

The drum is typically a substantially cylindrical shape. The drum typically has one end open such that textile substrates can be loaded into and unloaded out of the drum.

A door is optionally mounted adjacent to the open end of the drum. The door permits the textile substrate to be loaded into and unloaded out of the drum. The door also permits the apparatus to be closed and sealed such that whilst the treatment is performed no liquid escapes the apparatus.

The textile treatment apparatus preferably comprises a tub which surrounds the drum. The tub assists in preventing the leakage of liquids from the textile treatment apparatus and together with the door forms a liquid-tight seal.

Optionally a seal may be present in the door and/or on the outer surface of the tub facing the door. The seal assists in forming the desired liquid-tight seal during the treatment.

The textile treatment apparatus preferably comprises a storage compartment for storing solid particles. The storage compartment can take the form of a sump which is typically mounted below the drum and the tub. The storage compartment can be located at the rear or closed end of the drum furthest from the door. The storage compartment may take the form of one or more lifters. Lifters are elongate protrusions spaced on the internal surfaces of the drum and roughly parallel to the axis of rotation.

The textile treatment apparatus preferably comprises a dispensing means for transporting the solid particles from the storage compartment to the drum. The dispensing means can comprise a dispensing flow path comprising a pump suitable for pumping a mixture of liquid and solid particles.

The dispensing flow path begins at the storage compartment and ends at the drum.

The dispensing means can alternatively be a dispensing flow path fitted with one or more surfaces which tend to urge the solid particles towards and into the drum as the drum rotates. The surfaces can be a paddle which may be angled, a helical screw, a paternoster or a series of angled surfaces forming “V” shapes or herringbone type shapes.

The dispensing means may be regulated or actuated by a valve which may be opened and closed. A preferred example of a valve is a poppet value which is preferably located in the rear of the drum.

The textile treatment apparatus preferably comprises a collecting means for transporting the solid particles from the drum to the storage compartment. The collecting means can comprise a collecting flow path comprising an aperture in the drum and/or an aperture in a lifter located on the inner surface of the drum.

The collecting flow path typically starts in the drum or lifter and ends in the storage compartment, the storage compartment can be for example a sump located below the drum and the tub. Typically, the flow path is substantially following the downward direction such that gravity urges the solid particle along the collecting flow path.

Alternatively, the collecting means can comprise a collecting flow path comprising a paddle which may be angled, a helical screw, a paternoster or a series of angled surfaces forming “V” shapes or herringbone type shapes. The flow path may begin at an aperture in a lifter located on the inner surface of the drum and end in the storage compartment e.g. located at the rear of the drum.

Suitable textile treatment apparatus include those disclosed in PCT patent publications: WO2011/098815, WO2014/147391, WO2014/147389, WO2019/073270, WO2018/172725, WO2020/012026, WO2020/012024.

Storage Compartment

The storage compartment is preferably loaded with solid particles as hereinafter described prior to the treatment and preferably the solid particles are collected back into the storage compartment on completion of the treatment.

Control Unit

The textile treatment apparatus may comprise a control unit. The control unit is preferably able to actuate the filter unit. The control unit preferably comprises a central processor and memory, said memory being loaded with a programme, the programme being such that when operated it controls the actuation of the filter unit at the desired times in the treatment cycle. Thus, by way of example the programme may be configured to await the end of the treatment cycle, open the effluent outlet of the textile treatment apparatus, permit the effluent (feed) to enter the filter unit and actuate the filter unit such that it rotates whilst the effluent passes through the filter unit and out to the drain. In some alternative embodiments comprising a movable lid, the control unit may actuate movement of the moveable lid between the first and second configurations.

Solid Particles

The solid particles preferably have a particle size of at least 2 mm, preferably at least 3 mm, more preferably at least 4 mm, and especially at least 5 mm. In order of increasing preference the solid particles have a particle size of no more than 70 mm, no more than 50 mm, no more than 40 mm, no more than 30 mm, no more than 20 mm or no more than 10 mm. Preferably, the solid particles have particle size of from 1 to 20 mm, more preferably from 1 to 10 mm. Solid particles which offer an especially prolonged effectiveness over a number of treatment cycles are those with an particle size of at least 5 mm, preferably from 5 to 20 mm. The size is preferably the largest linear dimension (length). For a sphere this equates to the diameter. For non-spheres this corresponds to the longest linear dimension. The size is preferably determined using Vernier calipers. The size is preferably the mean size. The mean particle size is preferably an arithmetic mean. The determination of the mean particle size is preferably performed by measuring the particle size of at least 10, more preferably at least 100 solid particles and especially at least 1000 solid particles. The abovementioned particle sizes provide especially good performance (particularly cleaning performance) whilst also permitting the particles to be readily separable from the substrate at the end of the method.

The term solid particles as used herein preferably does not include within its scope the idea of undissolved treatment agents and/or dirt or other soiling materials which may be present in the textile substrate. Equally, solid particles as used herein preferably does not include within its scope any fibres which may detach or be shed from the textile substrate.

The solid particles may be polymeric and/or non-polymeric particles. Suitable non-polymeric solid particles may be selected from metal, alloy, ceramic and glass particles. Preferably, however, the solid particles are or comprise a polymer.

Preferably the solid particles comprise a thermoplastic polymer. A thermoplastic polymer, as used herein, preferably means a material which becomes soft when heated and hard when cooled. This is to be distinguished from thermosets (e.g. rubbers) which will not soften on heating. A more preferred thermoplastic is one which can be used in hot melt compounding and extrusion.

The polymer preferably has a solubility in water of no more than 1 wt %, more preferably no more than 0.1 wt % in water and most preferably the polymer is insoluble in water. Preferably the water is at pH 7 and a temperature of 20° C. whilst the solubility test is being performed. The solubility test is preferably performed over a period of 24 hours. The polymer is preferably not degradable. By the words “not degradable” it is preferably meant that the polymer is stable in water without showing any appreciable tendency to dissolve, disintegrate or hydrolyse. For example, the polymer shows no appreciable tendency to dissolve, disintegrate or hydrolyse over a period of 24 hrs in water at pH 7 and at a temperature of 20° C. Preferably a polymer shows no appreciable tendency to dissolve, disintegrate or hydrolyse if no more than about 1 wt %, preferably no more than about 0.1 wt % and preferably none of the polymer dissolves, disintegrates or hydrolyses, preferably under the conditions defined above.

The polymer may be crystalline or amorphous or a mixture thereof.

The polymer can be linear, branched or partly cross-linked (preferably wherein the polymer is still thermoplastic in nature), more preferably the polymer is linear.

The polymer preferably is or comprises a polyalkylene, a polyamide, a polyester or a polyurethane and copolymers and/or blends thereof, more preferably the polymer is or comprises a polyalkylene, polyamide or polyester, especially the polymer is or comprises a polyamide or a polyalkylene.

The solid particles can be of any suitable shape although spheres, spheroids, cylinders, ellipsoids and shapes intermediate between these are very much preferred.

Preferably the solid particles are re-used. More preferably, the solid particles are re-used in one or more subsequent treatments.

Method

According to a third aspect of the present invention there is provided a method of filtering a feed comprising microfibres using a filter unit according to the first aspect of the present invention or a textile treatment apparatus according to the second aspect of the present invention.

The method may comprise:
i. providing a filter unit according to the first aspect of the invention comprising an opening and a moveable member as described herein;
ii. placing the filter unit in the first configuration;
iii. supplying effluent from a textile treatment apparatus to the inlet of the filter unit;
iv. filtering the effluent through the filter medium and passing the filtered effluent to the outlet;
v. stopping the supply of effluent;
vi. placing the filter unit in the second configuration;
vii. rotating the filter cage to throw filter residue from the filter medium through the opening.

The method may further comprise the subsequent steps of:
vii. returning the filter unit to the first configuration;
ix. resuming supply and filtering of feed.

Preferably, in the method the feed comprising microfibres originates from a textile treatment apparatus.

Preferably, during filtration the filter cage is rotated at a speed such that the internal surface of the one or more filter media experiences a G force of at least 20 G.

Preferably, in order of increasing preference the abovementioned G force is at least 30 G, 40 G, 50 G and 60 G.

Such G forces not only assist in filtration but they also encourage the desired turbulent flow in the proximity of the one or more baffle surfaces and the one or more filter media.

The calculation of the G force is preferably done by the equation G=RPM²×1.118×10⁻⁵×r wherein RPM is revolutions per minute and r is the radius of the rotation expressed in centimetres.

So as an example, 1400 rpm rotation speed for filter media rotating about a radius of 4 cm equates to 88 G.

Preferably, in order of increasing preference the G force is no more than 100,000 G, no more than 50,000 G, no more than 10,000 G, no more than 5,000 G, no more than 1,000 G, no more than 500 G and no more than 300 G.

The G force is preferably that as calculated on the internal walls of the filter media.

In order of increasing preference, the filter cage and filter media are preferably rotated at a speed of at least 100 rpm, 200 rpm, 300 rpm, 500 rpm, 700 rpm, 900 rpm, 1100 rpm or 1200 rpm during filtration.

In order of increasing preference, the filter cage and filter media are preferably rotated at a speed of no more than 10,000 rpm, no more than 5,000 rpm, no more than 3,000 rpm or no more than 2,000 rpm during filtration.

The internal walls of the filter media are preferably distanced from the axis of rotation by a radius of at least 0.5 cm, at least 1 cm, at least 2 cm or at least 3 cm.

The internal walls of the filter media are preferably distanced from the axis of rotation by a radius of no more than 100 cm, no more than 50 cm, no more than 40 cm, no more than 30 cm, no more than 20 cm and no more than 10 cm.

In order of increasing preference, during filtration the turbulence at the surface of the filter media corresponds to a Reynolds number of at least 3000, at least 4000, at least 5000, at least 7000 or at least 10000.

Preferably, during filtration the turbulence at the surface of the filter media corresponds to a Reynolds number of no more than 10⁹, more preferably no more than 10⁸ and especially no more than 10⁷.

The surface of the filter media can be the innermost or more preferably the outermost surface for the purposes of calculating the Reynolds number.

Preferably the Reynolds number is the rotational Reynolds number, sometimes also known as the circular Reynolds number.

Turbulent flow may be visually assessed. So as an example, coloured particles can be added to the feed as it exits the filter media but remains within the filter unit and the paths of the coloured particles can be assessed visually. Turbulent flow can be observed visually and is noted where the paths of the coloured particles no longer take a smooth laminar flow but instead take up a more turbulent flow. This can be observed external to the filter media or optionally near to the outermost surface of the filter media. Turbulent flow often contains vortices and/or has chaotic paths. As an alternative example, coloured particles can be added to the feed as it enters the filter unit and the paths of the coloured particles can be assessed visually within the filter cage or optionally near the inner surface of the filter media. The word “near” in this specific context preferably means within 5 mm, 3 mm or 1 mm of the surface of the filter media. Turbulent flow can be observed visually and is noted where the paths of the coloured particles no longer take a smooth laminar flow but instead take up a more turbulent flow, either within the cage as a whole or near the inner surface of the filter media. Turbulent flow often contains vortices and/or has chaotic paths.

Preferably, the Reynolds number is calculated by Re=D*R*r²/DV wherein Re is the Reynolds number, D is the density of the feed present in the filter after passing through the filter media (Kg/m³), R is the rotational speed of the filter media (radians/s), r is the radius ie. the distance from the surface of the filter media to the axis of rotation, DV is the dynamic viscosity (Ns/m²) of the feed after it has passed through the filter media.

Since the liquid in the feed is most commonly water then D and DV are preferably substituted with known values for water. These values are preferably established as appropriate to the temperature of the feed after it has passed through the filter media. Thus, when the liquid in the feed is water the values can be established from known values for water at specific temperatures. The same can apply equally to feeds which comprise other liquids.

So as an example the Reynolds number of water at 20 degrees Celsius where the filter cage and filter media spin at 1400 rpm or 146.6 radians/sec when D is 997 Kg/m³, r is 0.04 m and DV is 0.001 (Ns/m²) can be calculated to be approximately 2.3×10⁵. A number of 2.3×10⁵ is considered to be highly turbulent.

Turbulence can also be calculated using computational fluid dynamics CFD. So as an example the COMSOL Multiphysics software can be utilised to calculate turbulence and Reynolds numbers.

The filter unit of the first aspect of the present invention is capable of operating by filtering the feed liquid when the feed liquid pass through the filter unit only once. Optionally, the feed is passed through the filter unit only once. This can be regarded as a single pass of the feed. This method works well for quick cleaning of the feed waste as it exits the grey waste outlet of a textile treatment apparatus. Such a single pass capability of the filter unit is particularly desirable for effluent from textile treatment apparatus and especially washing machines. It permits easy integration of the filter unit into such machines without necessitating recirculation loops, pressurized systems or additional storage tanks. Alternatively, it permits easy addition of the filter unit external to such machines again without necessitating recirculation loops, pressurized systems or additional storage tanks. The filter unit of the present invention and the single pass method contrast cross-flow filtration units and their methods where the feed has to be recycled through the filter many times, filtration takes time, recirculation pumps and pressurising pumps may be required.

Optionally, the feed is passed through the filter unit multiple times. This method works well for polishing where particularly high efficiency of removal of the microfibres are required.

Filtering Feed from Many Treatment Cycles

In order of increasing preference, the filter unit filters feed from at least 5, at least 10, at least 15, at least 20, at least 30, at least 50 and at least 100 textile treatment cycles before requiring any cleaning. Typically, the filter unit will require cleaning before feed from 1000 textile treatment cycles has been filtered. The necessity for cleaning can be established where the flow rate drops below 50% of its initial rate or more preferably where the abrupt reduction in the flow rate is noted.

The method is well suited to even the most challenging types of microfibres. Thus, the method works well even with microfibres that are or comprise a natural material (e.g. wool, cotton and silk) and especially that are or comprise a cellulosic material. An especially suitable cellulosic material is cotton, which may be in the form of denim.

Efficiency

The method according to the third aspect of the present invention, the filter unit according to the first aspect and the textile treatment apparatus according to the second aspect of the present invention are in order of increasing preference capable of removing at least 70%, at least 80%, at least 90%, at least 95% and at least 99% by dry mass relative to all the microfibres originally present in the feed.

The efficiency can be established by filtering any feed. The efficiency can be measured across a range of types of microfibres.

Preferably, the efficiency is established by firstly capturing and measuring the dry weight all of the microfibres from any treatment cycle collected using a filter bag having a pore size of 1 micron. The dry mass Wₜₒₜₐᵥ is usually an average. Wₜₒₜ is itself given by W_{f1}−Wᵢ₁ where W_{f1} is the final dry weight of the 1 micron filter bag plus the dry microfibres collected and W₁ is the dry weight of the initial filter bag prior to filtration. Wₜₒₜₐᵥ is simply the average of the Wₜₒₜ values, typically the average of 3×Wₜₒₜ values.

In a similar way, secondly any small amounts of microfibres which have passed through the filter unit can be established by capturing and measuring the dry weight of microfibres in the feed after it exits the filter unit and as collected on a 1 micron filter bag. This dry mass of microfibres having passed through the filter unit is W_{nc} which is itself calculated by W_{f2}−Wᵢ₂ where W_{f2} is the final dry weight of the 1 micron filter bad plus the dry microfibres collected and Wᵢ₂ is the dry weight of the initial filter bag prior to filtration.

The efficiency is then given by (Wₜₒₜₐᵥ−W_{nc})/Wₜₒₜₐᵥ×100.

Drying of the filter bag and the filtered microfibres is preferably performed at a temperature of 50 degrees Celsius for a period of a least 12 hours.

Even more demanding is the simultaneous achievement of high efficiency and many filtration cycles before blocking thus the present invention preferably is able to simultaneously achieve the above efficiencies and filter feed from the abovementioned numbers of treatment cycles.

Flow Rate

In order of increasing preference the flow rate of the feed through the filter unit is at least 1 litre/minute, at least 2 litres/minute, at least 3 litres/minute, at least 4 litres/minute, at least 5 litres/minute, at least 6 litres/minute, at least 7 litres/minute, at least 8 litres/minute, at least 9 litres/minute, at least 10 litres/minute, at least 15 litres/minute, at least 20 litres/minute or at least 25 litres/minute.

Typically, the flow rate will be no more than 1000 litres per minute, 500 litres per minute or 100 litres per minute.

Capacity

In order of increasing preference, the filter unit has a capacity of at least 100 mls, at least 250 mls, at least 750 mls, at least 1,000 mls or at least 2,000 mls.

Typically, the filter unit has a capacity of no more than 500,000 mls, no more than 100,000 mls, no more than 20,000 mls, no more than 10,000 mls, no more than 5,000 mls or no more than 3,000 mls.

The capacity is typically measured by closing the inlet and then adding water into the filter unit until it just begins to overflow from the outlet. This is typically done with water at a temperature of 20 degrees Celsius.

Flow Rate: Capacity

In order of increasing preference, the ratio of flow rate:capacity is at least 1:1, at least 2:1, at least 3:1, at least 4:1, at least 5:1, at least 6:1, at least 7:1, at least 10:1, at least 15:1, at least 20:1 or at least 25:1 when the flow rate is expressed in litres/minute and the capacity is expressed in litres.

The ratio of flow rate:capacity is typically no more than 1000:1, more typically no more than 500:1 or no more than 100:1.

### FIGURES IN SUMMARY

FIG. 1a shows a first baffle surface as can be used in the filter unit of the first aspect of the present invention, the baffle surface is shown in plan view.

FIG. 1b shows a first baffle surface as can be used in the filter unit of the first aspect of the present invention, the baffle surface is shown in isometric perspective.

FIG. 2a shows a second baffle surface as can be used in the filter unit of the first aspect of the present invention, the baffle surface is shown in plan view.

FIG. 2b shows a second baffle surface as can be used in the filter unit of the first aspect of the present invention, the baffle surface is shown in isometric perspective.

FIG. 3a shows a filter unit according to the first aspect of the present invention in cross-sectional view.

FIG. 3b shows a filter unit according to the first aspect of the present invention as an exploded view.

FIG. 4 shows a schematic of a first textile treatment apparatus according to the second aspect of the present invention.

FIG. 5 shows a schematic of a second textile treatment apparatus according to the second aspect of the present invention.

FIG. 6 shows a schematic of a third textile treatment apparatus according to the second aspect of the present invention.

FIG. 7a shows an isometric view of an alternate filter unit according to the present disclosure, with the filter in a first configuration.

FIG. 7b shows an isometric view of an alternate filter unit according to the present disclosure, with the filter unit in a second configuration.

FIG. 7c shows a cross-section through the alternate filter unit, with the filter unit in a first configuration.

FIG. 7d shows an isometric cross section of a housing of the alternate filter unit, with the filter unit in a first configuration.

FIG. 7e shows an isometric cross section of a housing of the alternate filter unit, with the filter unit in a second configuration.

FIG. 7f shows a side view of a housing of the alternate filter unit, with the filter unit in a second configuration.

FIG. 7g shows a side view of a filter cage of the alternate filter unit.

### FIGURES IN DETAIL

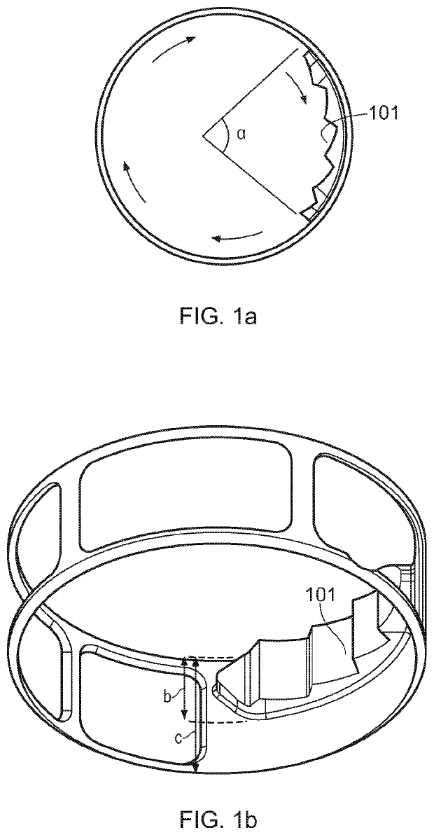

FIG. 1a shows first baffle surface (101) in the form of five saw-teeth which conform to the curvature of a cylinder. The teeth are continuous for approximately 90 degrees of radial angle when considering the rotation of the cage and when viewed down the axis of rotation. Thus, the angle α in FIG. 1a is approximately 90 degrees. The arrows show the direction of the rotation of the filter cage relative to the baffle surface.

FIG. 1b shows the same baffle surface (101) as that of FIG. 1b but in isometric perspective. It can be seen that the label (b) which is the axial length of the baffle surface covers approximately 50% of the axial length of the filter media shown by label (c).

The baffle surface (101) in FIGS. 1a and 1b is the same as that as mentioned below in the examples as BS1.

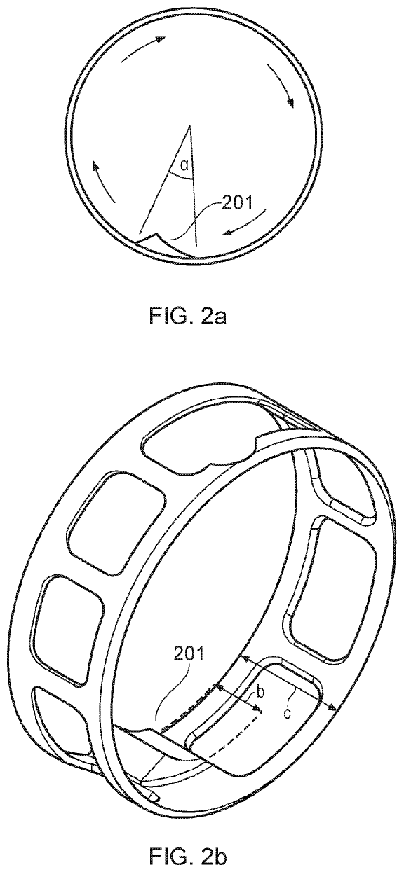

FIG. 2a shows a second baffle surface (201). The baffle surface has one tooth which conforms to the curvature of a cylinder. The tooth is continuous for approximately 30 degrees of radial angle when considering the rotation of the cage and when viewed down the axis of rotation. Thus, the angle α in FIG. 2a is approximately 30 degrees. The arrows show the direction of the rotation of the filter cage relative to the baffle surface.

FIG. 2b shows the second baffle surface (201) this time in isometric perspective.

The baffle surface (201) in FIGS. 2a and 2b is the same as that mentioned below in the examples as BS2.

It can be seen that the label (b) which is the axial length of the baffle surface covers approximately 50% of the axial length of the filter media shown by label (c).

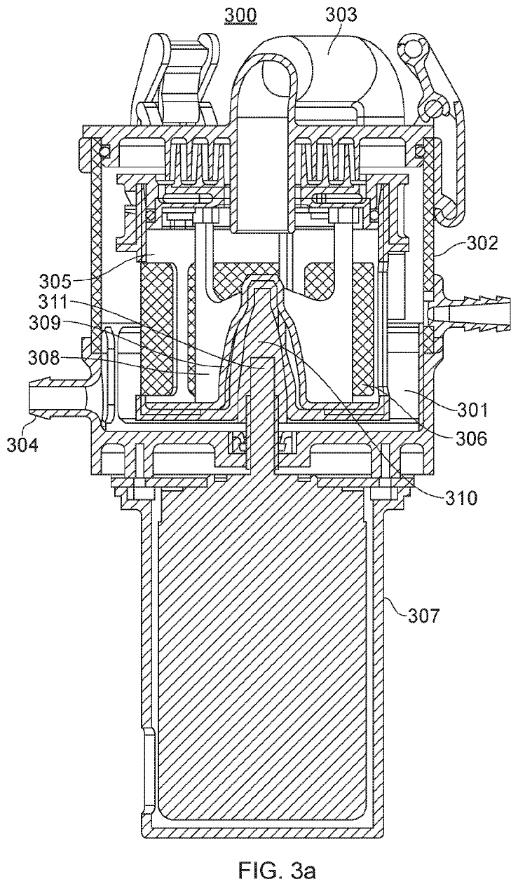

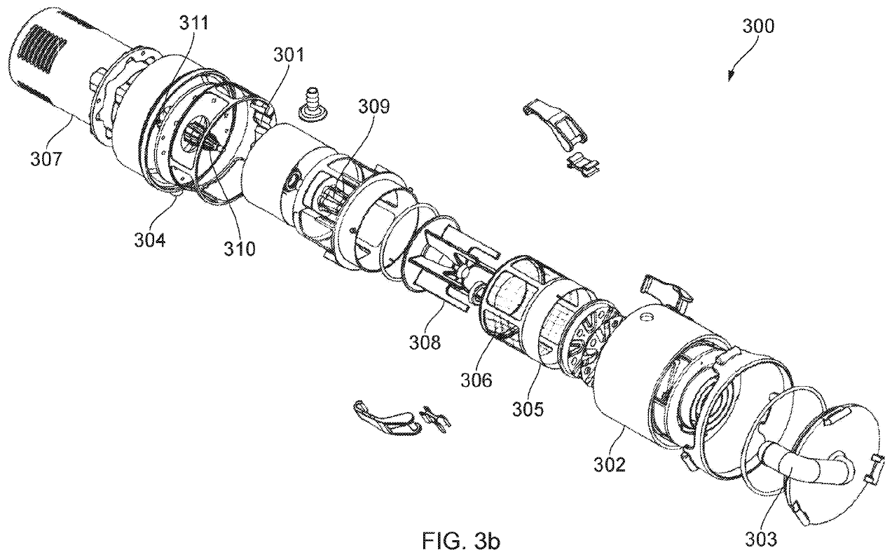

FIGS. 3a and 3b shows a filter unit (300) comprising a baffle surface (301), a housing (302) in the form of a cylinder, an inlet (303) and outlet (304), a filter cage (305), filter media (306), a drive means in the form of an electric motor (307). The filter also comprises an impeller (308) located within the filter cage. The filter cage is fitted with a mating surface (309) which engages a spline (310) located at the end of a drive shaft (311) extending from the electric motor.

When in use feed comprising microfibres enters the inlet of the filter unit (303). The electric motor (307) is actuated so as to rotate the filter cage which supports the filter media. The feed is directed towards the interior of the filter cage, the feed then passes through the filter media and exits as a filtered liquid via the outlet (304). The impeller (308) assists in driving the feed through the filter media and thereby improves the flow rate. The baffle surface (301) is located adjacent to the exterior surface of the filter media (306). During rotation of the filter cage (305), the filter media (306) move relative to the baffle surface (301) and turbulent flow of liquid is encouraged near the exterior surface of the filter media. The turbulent flow is believed to advantageously help to prevent microfibres from blocking the filter media.

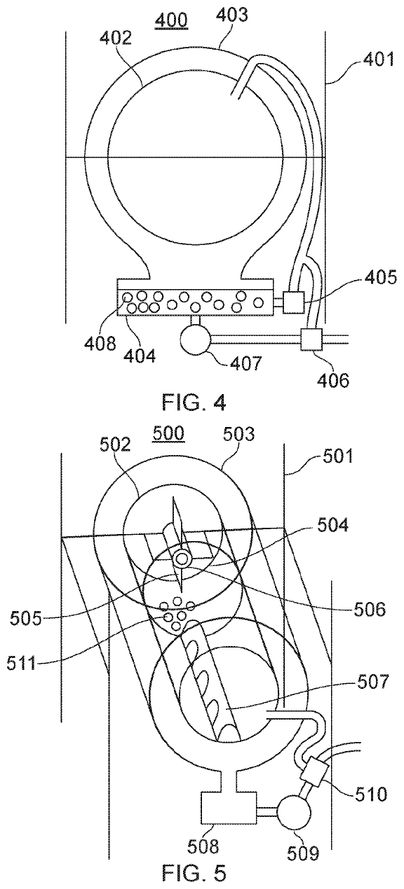

FIG. 4 shows a textile treatment apparatus (400) which comprises:
a frame (401);
a drum (402) which is rotatably mounted in the frame (401);
a tub (403) which surrounds the drum;
a storage compartment (404) for storing solid particles.
a dispensing means (405) in the form of a pump for transporting the solid particles from the storage compartment to the drum;
a collecting means for transporting the solid particles from the drum to the storage compartment which takes the form of holes in drum (not shown) and a storage compartment (404) in the form of a sump which is located directly underneath the drum.

FIG. 4 also comprises a filter unit (407) according to the first aspect of the present invention. Filtered feed exiting the filter unit (407) may go to the outlet as effluent or can be recycled back to the drum depending on the valve (406). Solid particles (408) are shown in the storage compartment (404).

FIG. 5 shows a textile treatment apparatus (500) which comprises:
a frame (501);
a drum (502) which is rotatably mounted in the frame (501);
a tub (503) which surrounds the drum;
a storage compartment (504) for storing solid particles which is located in the rear of the drum.
a dispensing means (505) which is in the form of angled surfaces which during rotation move the solid particles towards a poppet valve (506);
a collecting means for transporting the solid particles from the drum to the storage compartment which takes the form of lifters having holes to permit entry of the solid particles, the lifters (507) having internal flow paths leading from the treatment area of the drum to the rear of the drum and which comprise a paternoster arrangement. During rotation of the drum the paternoster arrangement urges solid particles entering the lifter towards the storage compartment at the rear of the drum. By opening the poppet valve the solid particle can be dispensed into the treatment area of the drum or by closing the poppet valve the solid particles can be collected automatically back in to the rear storage area of the drum. The textile treatment apparatus of FIG. 5 also comprises a sump (508) fluidly connected to a filter unit (509) according the first aspect of the present invention. Filtered feed exits the filter unit (509) and as controlled by a valve (510) may go to the outlet as effluent or may be recycled to the drum either directly or via a path which permits the filtered feed to pass through a detergent compartment (not shown). Solid particles (511) are shown in the storage compartment (504) at the rear of the drum.

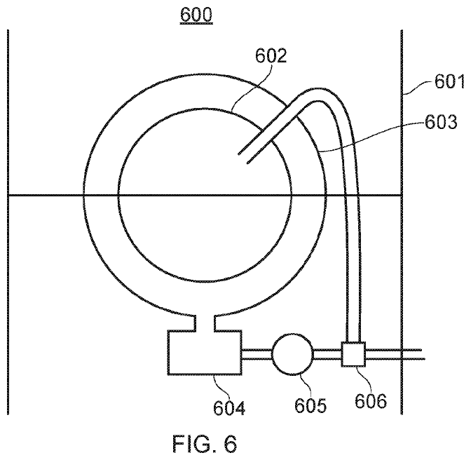

FIG. 6 shows a textile treatment apparatus in the form of a conventional washing machine which comprises which comprises:
a frame (601);
a drum (602) which is rotatably mounted in the frame (601);
a tub (603) which surrounds the drum;
a sump (604) fluidly connected to a filter unit (605) according to the first aspect of the present invention. The filtered feed exits the filter unit to a valve (606) which can be operated to recycle the filtered feed to the drum (either directly or via a path which permits the filtered feed to pass through the a detergent compartment—not shown) or to the waste outlet as effluent.

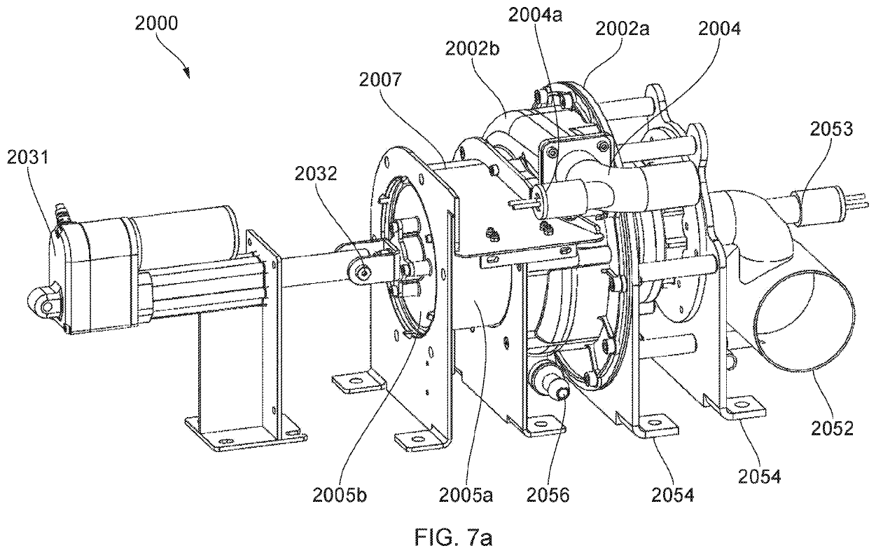

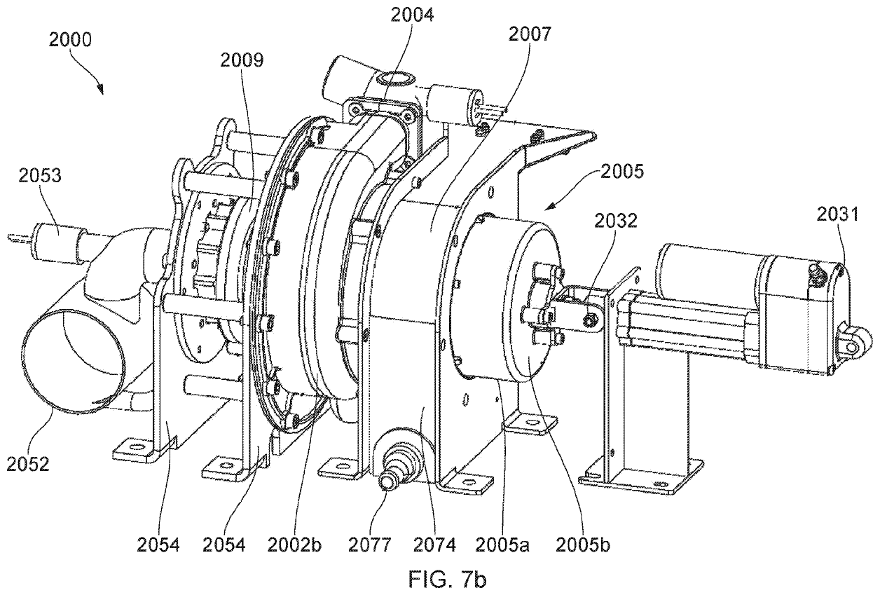

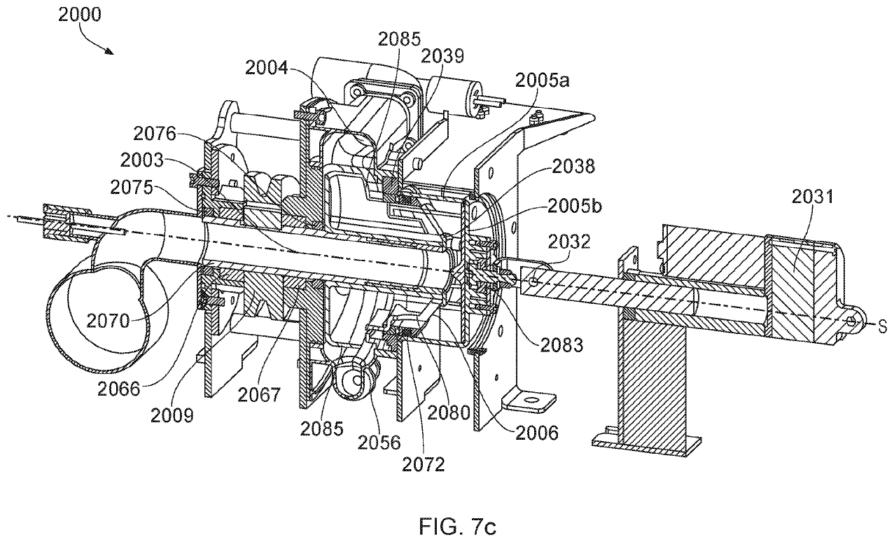

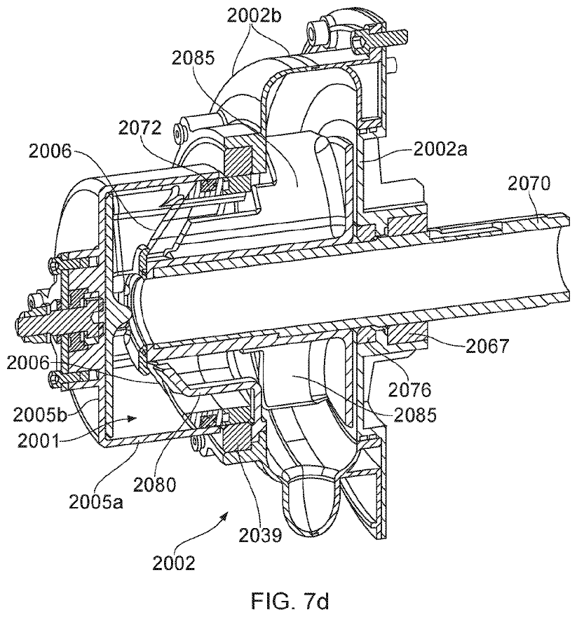

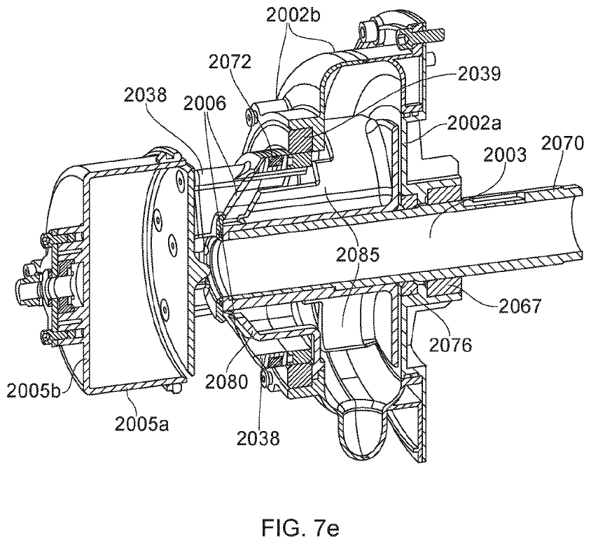

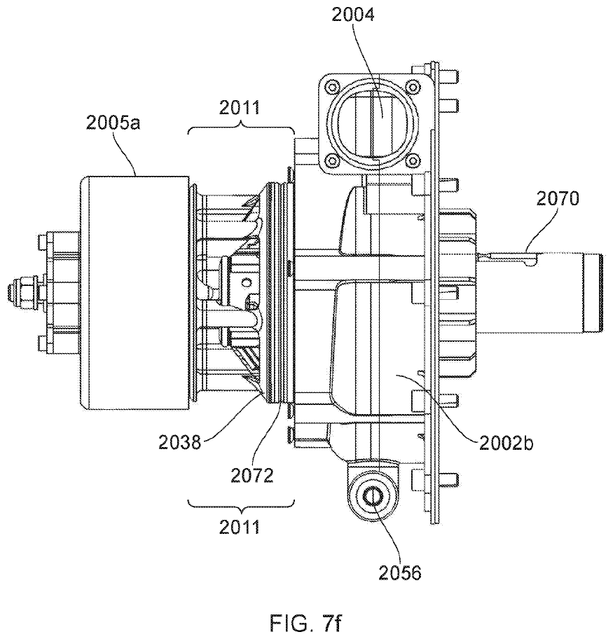

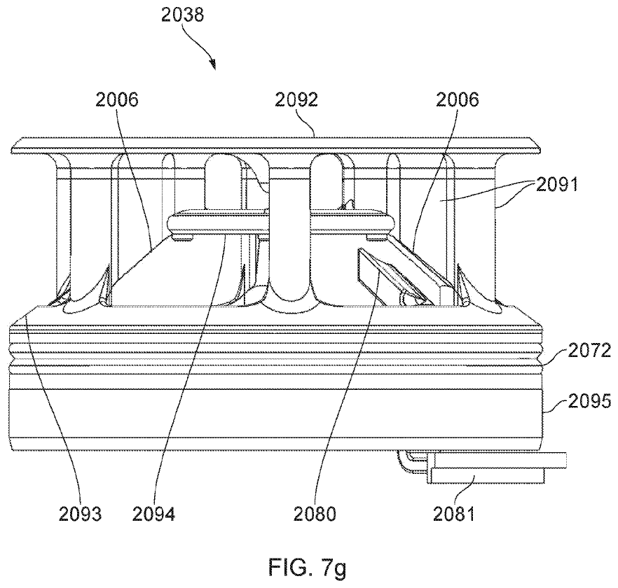

FIGS. 7a to 7c show an alternative embodiment of a filter unit 2000. FIGS. 7d, 7e and 7f show a housing 2001 of the filter unit 2000 and FIG. 7g shows a filter cage 2038 of the filter unit 2000. The filter unit 2000 comprises a housing 2001. The housing 2001 comprises a moveable lid 2005. The moveable lid 2005 is in the form of a hollow cylinder closed at one end and comprising a cylindrical sidewall 2005a and a circular end wall 2005b. The housing 2001 also comprises an end wall 2002a and a sidewall 2002b. The sidewall 2002b is in a volute shape with a tangential port which extends to form an outlet 2004 from the housing 2001. The outlet comprises a valve 2004a to control the flow of filtered feed out of the housing 2001. The sidewall 2002b also comprises a secondary drain 2056 at bottom of the sidewall. The end wall 2002a comprises an opening therein which is the inlet 2003 to the housing 2001. A pipe 2070 passes through the opening of the inlet 2003. The pipe 2070 supplies feed into the housing 2001 through the inlet 2003. The pipe 2070 is configured to rotate about central axis S which is aligned in the horizontal direction. The pipe 2070 is mounted to the housing 2001 via bearings 2067 and 2066, which connect via mount 2054. A seal 2076 is present between the end wall 2002a and the pipe 2070 to prevent leakage of feed. The pipe 2070 is also connected to a supply pipe 2052 to receive feed from a textile treatment apparatus. A seal 2075 prevents leakage of feed from between the supply pipe 2052 and the pipe 2070. The supply pipe 2056 comprises a valve 2053 to control supply of feed into the filter unit 2000.

Inside the housing 2001 is a frusto-conical filter medium 2006. The housing is shown in detail in FIGS. 7d to 7f. The external, outward facing surface of the filter medium 2006 is the first surface of the filter medium 2006 which receives unfiltered feed from pipe 2070. The internal inward facing surface of the filter medium 2006 is the second surface of the filter medium 2006 from which filtered feed passes. The filter medium 2006 is supported by the filter cage 2038. The filter cage 2038 is configured to rotate about the central axis S. The filter cage 2038 is shown in greater detail in FIG. 7g. The filter cage 2038 comprises two annular supports 2093, 2094 angled to support the filter medium 2006 in the frusto-conical shape. The filter cage 2038 also comprises a plurality of blades 2091 proximal to and upstream of the first surface of the filter medium 2006. These blades, when rotated act to enhance rotation of the unfiltered feed in the housing 2001, which assists in pumping feed though the filter unit 2000, thus the blades function as an impeller. The blades connect to a disc 2092 which contacts the circular endwall 2005b of the movable lid 2005 when the moveable lid 2005 is in the first configuration. The filter cage 2038 also comprises an annular X-seal 2072 around the outer circumference. The X-seal 2072 contacts the inner circumference of the sidewall 2005a of the moveable lid 2005 when in the first configuration to prevent leakage of feed liquid. The filter cage 2038 also comprises a smooth surface 2095 on the outer circumference for rotation against a seal 2039 connected to housing 2001. Also contained within the housing 2001 is an impeller 2085 which extends from proximal to the second surface of the filter medium to adjacent to the end wall 2002a. The impeller 2085 comprises a plurality of blades with a profile that occupies most of the volume of the housing 2001 downstream of the filter medium 2006. The impeller 2085 comprises a hollow bore with the pipe 2070 located therein. The impeller 2085 is configured to rotate around the central axis S and rotates with the pipe 2070, filter cage 2038 and filter medium 2006. Rotation of the impeller 2085 helps to drive filtered feed from the volute part of the housing 2001 and draws unfiltered feed into the housing 2001 via inlet 2003 and the pipe 2070.

The moveable lid 2005 is moved between the first and second configurations by the linear actuator 2031 which is directly connected to the moveable lid by linkage 2032 and the bearing 2083, which each permit rotation in different directions. The moveable lid 2005 is moved between the first and second configuration in the horizontal direction. When the movable lid is in the second configuration, an annular opening 2011 is present between the cylindrical sidewall 2005a of the moveable member 2005 and the sidewall 2002b of the housing 2001. FIG. 7f illustrates the opening 2011. FIGS. 7a and 7d show the movable lid 2005 in the first configuration and FIGS. 7b, 7c, 7e and 7f show the moveable lid 2005 in the second configuration.

Radially outwards of the opening 2011 is a container 2007 for receiving filtride from the first surface of the filter medium. The container 2007 is shown in FIG. 7b only and in part in FIGS. 7a and 7c. The container 2007 is generally cylindrical and extends 360 degrees around the central axis. A bottom quadrant of the container 2007 comprises a detachable portion in the form of a tray 2074. The tray 2074 can slide out from the filter unit 2000 for emptying by a user. The container 2007 also comprises a tertiary drain 2077 for draining any residual liquid in the bottom of the container 2007.

The filter unit 2000 comprises a drive means (not shown) e.g., an electric motor. The filter medium 2006 is rotatable around the central axis by the drive means. Filter residue can be removed from the first surface of the filter medium 2006 by rotating the filter medium 2006 to induce a centrifugal force to throw the filter residue radially outwards off the filter medium 2006. The drive means is connected to the filter medium 2006 via a belt (not shown) and pulley 2009 connected to the pipe 2070. Rotation of the drive means rotates the pulley 2009 which in turn rotates the impeller 2085, the filter cage 2038 and the filter medium 2006.

Proximal to the second surface of the filter medium 2006 is a baffle surface 2080. The baffle surface 2080 is shown in detail in FIG. 7g along with the filter cage 2038. The baffle surface 2080 is connected to the sidewall 2002b of the housing 2001 by the baffle support 2081. The baffle surface 2080 is static and does not rotate with the filter medium 2006. The baffle surface 2080 affects fluid flow close to the filter medium 2006 which reduces the tendency of the filter medium 2006 to become blocked with filter residue.

In use the filter unit is placed in the first configuration, where the moveable lid 2005 is in contact with the seal 2072. In this configuration the housing 2001 is sealed so that the feed may enter only via the inlet 2003 and leave via the outlet 2004 and optionally via the secondary drain 2056. Feed is supplied to the housing 2001 from a textile treatment apparatus through the supply pipe 2052. If the valve 2053 is open, feed passes into the pipe 2070, where it is carried through the inlet 2003 into the housing 2001 and along the interior of the impeller 2085, through the middle of the filter cage 2038, the feed leaves the interior of the impeller 2085 and thus exits from the filter cage 2038, and then passes through the first surface of the filter medium 2006. The filter cage 2038, filter medium 2006, impeller 2085 and pipe 2070 are all rotated together by rotation of pulley 2009 by a belt (not shown) and drive means (not shown). Rotation of the impeller 2085 and blades 2091 may function as a centrifugal pump to draw feed into the housing 2001 through the inlet 2003 and expel feed from the housing 2001 via the outlet 2004. After the feed from the textile treatment apparatus has been filtered, the flow of feed is stopped, which may optionally be by valve 2053.

Residual feed liquid is then allowed to drain from the housing 2001 through the secondary drain 2056. The filter unit 2000 is then placed in the second configuration by moving the moveable lid 2005 to the second configuration with the linear actuator 2031. The filter medium 2006, pipe 2070, impeller 2085 and filter cage 2038 are then rotated at a sufficiently high speed to throw the filter residue from the first surface of the filter medium 2006, through the opening 2011, where it is collected in the container 2007 and falls to the bottom under gravity. Any residual liquid in the filter residue in the container 2007 can be drained via the tertiary drain 2077. After one or more of the above cycles, the residue accumulated in the container 2007 can be removed by sliding the tray 2074 out the filter container 2007 and transferring the residue out of the tray 2074 for disposal.

### EXAMPLES

The present invention will now be illustrated using the following non-limiting examples.

Textile Treatment Apparatus

The Textile Treatment Apparatus used to prepare the feeds for filtration was a commercially available Beko washing machine (herein BK1) model number WM5102W having a load capacity of 5 Kg.

Textile Substrate

The textile substrate used along with the textile treatment apparatus (BK1) which provided the microfibres in the feed was in the form of polycotton jumpers (herein PJ1) as supplied by Primark. These polycotton jumpers were all prewashed (PW) 4 times in a cotton 40 degrees cycle in a Beko washing machine model number WMB91233LW.

Textile Treatment Cycle

The Beko washing machine (BK1) was loaded with 1.5 Kg of polycotton jumpers.

The textile treatment cycle used in the Beko washing machine (BK1) loaded with the polycotton jumpers (PJ1) was a 40 degrees cotton cycle, using approximately 47 Kg of water and taking a time of 90 minutes. No detergent or additives were present in the treatment cycle. The cycle included a spin dry.

Tumble Drying

After each textile treatment cycle the polycotton jumpers (PJ1) were unloaded from the washing machine (BK1) and tumble dried. The tumble drying took 30 minutes at a temperature of 60 degrees Celsius in an Electrolux T4250 tumble dryer. The polycotton jumpers can then be re-used to prepare further microfibre containing feeds when loaded into BK1 and treated using the abovementioned textile treatment cycle. Once the polycotton jumpers have been through 30 cycles of textile treatment they are no longer used and instead they are replaced with a fresh set of polycotton jumpers. Each fresh set of polycotton jumpers were prewashed (PW) exactly as indicated above prior to any textile treatment cycles.

Poly Cotton Feed

Following each textile treatment cycle the feed (effluent from BK1) was stored in a first tank.

Filter Unit

Three different filter units were used to filter the effluent from BK1 stored in the first tank.

In every case the filter unit had the same cylindrical housing and the drive means was in the form of the same electrical motor. In all cases the filter media was in the form of a cylindrical shaped Nylon mesh having pores and which was glued to the filter cage.

### Comparative Example 1

In Comparative Example 1 the filter unit—Comparative filter Unit 1 (CFU1) was fitted with a woven Nylon mesh filter media having a pore size of 36 microns. CFU1 had no baffle surfaces present and was accordingly not within the scope of the present invention.

### Comparative Example 2

In Comparative Example 2 the filter unit—Comparative filter Unit 2 (CFU2) was fitted with a woven Nylon mesh filter media having a pore size of 140 microns. CFU2 had no baffle surfaces present and was accordingly not within the scope of the present invention.

### Example 1

In Example 1 the filter unit—Example filter unit 1 (EFU1) was exactly as per CFU1 but it additionally comprised a baffle surface (BS1) formed by 3D printing and which was constructed from ABS. As mentioned above BS1 is as shown in FIGS. 1a and 1b. BS1 was located within the filter unit such that the baffle surface occupied the lowermost (furthest from the inlet) portion of the internal space within the housing. Thus, there existed a portion axially above this where no baffle surface was adjacent to the filter media.

The baffle surface (BS1) was in the form of a saw-tooth wave. The baffle surface covered 90 degrees of the axis of rotation of the filter cage. The baffle surface covered 50% of the axial length of the filter media surface. The saw-tooth wave had an amplitude of 8 mm. The saw-tooth wave was 5 mm from the filter media, i.e. it had a nearest distance from the any point on the baffle surface to the filter media of 5 mm. The baffle surface was located adjacent to the exterior surfaces of the filter media. The baffle surface was located within the housing and conformed to the cylindrical shape of the housing. The baffle surface was static. The baffle surface had several teeth.

Filter Unit Operation and Method

In each case the first tank and the feed were located above the filter units. The filter units were primed with the feed and the feed was then allowed to pass through the filter unit via gravity and assisted by a second pump. The flow rate was simply that which the gravity and the second pump determines. This was approximately 7 litres per minute. The feed was passed through the filter unit just once. Whilst the feed was passed through each filter unit the electric motor was activated and the filter cage and filter media were rotated at a speed of 1400 rpm. This resulted in a G force at the internal surface of the filter media of 88 G. The rotation of the filter cage and filter media in concert with the baffle surface also encouraged and provided turbulent flow near the exterior of the filter media.

Second Tank

A second tank was used to capture and store the feed after it has passed through the filter unit on every occasion.

The contents of the second tank are then passed through a filter bag of known initial dry weight (Wᵢ) having a pore size of 1 micron.

Efficiency

Each filter bag, after collecting the microfibres from the second tank was dried in an oven at 50 degrees Celsius for a minimum of 12 hours.

The final dry filter bags along with dry microfibres not collected by the filter unit were weighed (W_{f}).

The mass of microfibres not collected W_{nc} by the filter unit was given by W_{f}−Wᵢ.

The total mass of microfibres which were released from the textile substrate were established by passing the feed from BK1 directly through a 1 micron bag. An average was then taken from 3 measurements. This provided the average total mass of microfibres Wₜₒₜₐᵥ.

The efficiency in each case is then given by (Wₜₒₜₐᵥ−W_{nc})/Wₜₒₜₐᵥ×100.

Higher efficiencies represent a more successful filtration by the filter unit.

The efficiency was averaged. The average efficiency was that taken from efficiencies for the first three and last three filtration cycles, however for comparative example 2 the average was taken from all successful washes.

Successful Number of Filtration Cycles

Successive full feeds from each treatment cycle were passed through each filter unit.

The number of feeds successfully filtered (successful filtration cycles) was recorded for each of the filter units. The point of blockage where the filtration cycles fail was determined by an abrupt reduction in the feed flow rate through the filter unit.

The number of successful filtration cycles does not include the cycle in which the filter unit blocks. Thus, as an example a filter unit which blocks on the 12^{th} treatment cycle is recorded as having 11 successful filtration cycles.

Results

The results were as summarised in Table 1.

TABLE 1
Showing the average efficiency and number of successful filtration cycles
for different feeds and for different filter media pore sizes.

| | | PolyCotton |
|---|---|---|
| | | Successful |
| | Polycotton | number of |
| | Efficiency (%) | filtration cycles |
| Comparative | n/a (could not be | 0 (blocks on the |
| Example 1 | measured as it | 1^{st} filtration |
| 36 Micron filter | blocked prior to | cycle) |
| media, with no | completion of a | |
| baffle surface | single filtration | |
| present | cycle) | |
| Comparative | 64 | 11 |
| Example 2 | | |
| 140 Micron Filter | | |
| media, with no | | |
| baffle surface | | |
| present | | |
| Example 1 | 73 | >15 |
| 36 micron filter | | |
| media, with | | |
| baffle surface | | |
| present | | |

### Examples 2 and 3

Examples 2 and 3 were performed in exactly the same way as Example 1 with the exceptions that:
i. the flow rate of the feed through the filter unit was 30 litres per minute, this resulted from connecting the filter unit to pipes with somewhat a wider diameter;
ii. The efficiency was calculated as an average of only the first 3 filtration cycles;
iii. The two different baffle surfaces were compared in two separate filter units.

For Example 2 the filter Unit was CFU1 fitted with baffle surface BS1 again with the baffle surface located in the lowermost (furthest from the inlet) portion of the filter unit.

For Example 3 the filter unit was CFU1 fitted a different Baffle Surface (BS2). BS was as shown in FIGS. 2a and 2b. BS2 was a single wave in the form of a single saw-tooth, the baffle surface covered 30 degrees of the axis of rotation of the cage, the baffle surface was located in the upper portion of the filter unit towards the inlet, the saw-tooth had an amplitude of 8 mm and was separated from the filter media surface by a nearest distance of 5 mm. The filter unit was such that there remained a portion of the filter media below the baffle surface axially where there was no baffle surface adjacent to it. The baffle surface was made from polylactic acid (PLA).

Results

| | | Number of successful |
|---|---|---|
| | Efficiency (%) | filtration cycles |
| Example 2 | 73 | >15 |
| Example 3 | 83 | >15 |

Table 2: shows the average efficiency of filtration along with the number of successful filtration cycles for examples 2 and 3.

### CONCLUSION

The results in Table 2 show that the baffle surface in Example 2 using a single saw-tooth is even more effective than that of Example 1 using several saw-teeth

General

In the present invention, any items expressed in the singular are also intended to encompass the plural unless stated to the contrary. Thus, words such as “a” and “an” mean one or more.

The words one or more also mean one or more than one.

The following numbered clauses are not the claims. The claims are defined in the following section titled “Claims”.
1. A filter unit suitable for filtering microfibres within a feed, the filter unit comprising:
   a) a housing;
   b) an inlet configured to allow the feed to enter the housing;
   c) an outlet configured to allow a filtered feed to exit the housing;
   d) a filter cage supporting one or more filter media, the filter cage being rotatably mounted and rotating about an axis of rotation within the housing, the filter media having pores with a mean pore size of no more than 100 microns;
   e) one or more baffle surfaces being located adjacent to at least a portion of the interior and/or exterior surfaces of the one or more filter media;
   the baffle surfaces and filter cage being configured such that during rotation of the filter cage, the one or more filter media move relative to the one or more baffle surfaces and turbulent flow of liquid when present in the filter unit is encouraged near the interior and/or exterior surface of the one or more filter media;
   f) a drive means for rotating the filter cage;
   g) the filter unit being configured such that feed from the inlet is directed towards the interior of the filter cage, the feed then passes through the one or more filter media and exits as a filtered liquid via the outlet.
2. A filter unit according to clause 1 wherein the one or more baffle surfaces have one or more waves.
3. A filter unit according to clause 2 wherein the one or more baffle surfaces have a wave with a shape which repeats.
4. A filter unit according to clause 2 or clause 3 wherein the wave is or comprises a square wave, arc wave, sine wave, triangular wave or a combination thereof.
5. A filter unit according to clause 4 wherein the shape of the baffle surface is an arc wave or a saw tooth wave.
6. A filter unit according to any one of clauses 2 to 5 wherein:
   the one or more waves on the one or more baffles provide a variation in the distance from any point on the baffle surface to the filter media, when measured along any radial direction towards the axis of rotation of the filter cage;
   the one or more waves on the one or more baffles provide a furthest distance from the any point on the baffle surface to the filter media, when measured along any radial direction towards the axis of rotation of the filter cage; and the variation in the distance is at least 5% of the furthest distance.
7. A filter unit according to any one of clauses 2 to 6 wherein:
   the one or more waves on the one or more baffles provide a variation in the distance from any point on the baffle surface to the filter media, when measured along any radial direction towards the axis of rotation of the filter cage; and
   the variation in the distance is at least 2 mm.
8. A filter unit according to any one of the preceding clauses wherein at least one baffle surface is continuous through an angle of at least 10 degrees around the axis of rotation of the filter cage and measured in a plane perpendicular to the axis of rotation of the filter cage.
9. A filter unit according to clause 8 wherein at least one baffle surface is continuous through an angle of at least 20 degrees.
10. A filter unit according to any one of the preceding clauses wherein the baffle surface(s) cover no more than 90% of the axial length of the one or more filter media.
11. A filter unit according to any one of the preceding clauses wherein the baffle surface(s) cover no more than 70% of the axial length of the one or more filter media.
12. A filter unit according to any one of clauses 10 or 11 wherein the baffle surface(s) do not cover at least 5 mm in length along the axial direction of the one or more filter media.
13. A filter unit according to any one of the preceding clauses wherein the pores in the one or more filter media have a mean pore size of from 1 to 100 microns.
14. A filter unit according to any one of the preceding clauses wherein the one or more baffle surface are static.
15. A filter unit according to any one of the preceding clauses wherein the one or more baffle surfaces are located adjacent to the exterior surfaces of the one or more filter media.
16. A filter unit according to any one of the preceding clauses wherein the one or more filter media are in the form of a non-woven mesh, a woven mesh, a knitted mesh or a perforated sheet.
17. A textile treatment apparatus comprising a filter unit according to any one of the preceding clauses.
18. A textile treatment apparatus according to clause 17 which is a washing machine.
19. A method of filtering a feed comprising microfibres using a filter unit according to any one of clauses 1 to 16 or a textile treatment apparatus according to clause 17 or 18.
20. A method according to clause 19 wherein the feed comprising microfibres originates from a textile treatment apparatus.
21. A method according to clause 19 or 20 wherein during filtration the filter cage is rotated at a speed such that the internal surface of the one or more filter media experiences a G force of at least 20 G.
22. A method according to any one of clauses 19 to 21 wherein during filtration the turbulence at the outermost surface of the filter media corresponds to a Reynolds number of is at least 3000.
23. A method according to any one of clauses 19 to 22 wherein the feed is passed through the filter unit only once.
24. A method according to any one of clauses 19 to 22 wherein the feed is passed through the filter unit multiple times.
25. A method according to any one of clauses 19 to 24 wherein the filter unit filters feed from at least 5 textile treatment cycles before requiring any cleaning.
26. A method according to any one of clauses 19 to 25 wherein the microfibres are or comprise a cellulosic material.
27. A method according to any one of clauses 19 to 26 wherein the microfibres have a longest linear dimension of less than 1 mm.
28. A method according to any one of claims 19 to 27 wherein the efficiency of the filter unit at removing microfibres is at least 70% by mass relative to all the microfibres originally present in the feed.
29. A method according to any one of clauses 19 to 28 wherein the flow rate of the feed through the filter unit is at least 1 litre/minute.

1. A filter unit suitable for filtering microfibres within a feed, the filter unit comprising:
a) a housing;
b) an inlet configured to allow the feed to enter the housing;
c) an outlet configured to allow a filtered feed to exit the housing;
d) a filter cage supporting one or more filter media, the filter cage being rotatably mounted and rotating about an axis of rotation within the housing, the filter media having pores with a mean pore size of no more than 100 microns;
e) one or more baffle surfaces being located adjacent to at least a portion of the interior and/or exterior surfaces of the one or more filter media;
the baffle surfaces and filter cage being configured such that during rotation of the filter cage, the one or more filter media move relative to the one or more baffle surfaces and turbulent flow of liquid when present in the filter unit is encouraged near the interior and/or exterior surface of the one or more filter media;
f) a drive means for rotating the filter cage;
g) the filter unit being configured such that feed from the inlet is directed towards the interior of the filter cage, the feed then passes through the one or more filter media and exits as a filtered liquid via the outlet.

2. A filter unit according to claim 1 wherein the one or more baffle surfaces are located either radially outward from or radially inward from the one or more filter media.

3. A filter unit according to claim 1 wherein the one or more baffle surfaces is adjacent to at least a portion of the exterior surface of the one or more filter media.

4. A filter unit according to claim 1 wherein the one or more baffle surfaces is connected to the housing and remains static during rotation of the filter cage.

5. A filter unit according to claim 1 wherein the one or more baffle surfaces have one or more waves.

6. A filter unit according to claim 5 wherein the wave is or comprises a square wave, arc wave, sine wave, triangular wave or a combination thereof.

7. A filter unit according to claim 5 wherein:
the one or more waves on the one or more baffles provide a variation in the distance from any point on the baffle surface to the filter media, when measured along any radial direction towards the axis of rotation of the filter cage;
the one or more waves on the one or more baffles provide a furthest distance from the any point on the baffle surface to the filter media, when measured along any radial direction towards the axis of rotation of the filter cage; and
the variation in the distance is at least 5% of the furthest distance.

8. A filter unit according to claim 5 wherein:
the one or more waves on the one or more baffles provide a variation in the distance from any point on the baffle surface to the filter media, when measured along any radial direction towards the axis of rotation of the filter cage; and
the variation in the distance is at least 2 mm.

9. A filter unit according to claim 1 wherein the at least one baffle surface is parallel to the filter media.

10. A filter unit according to claim 1 wherein the at least one baffle surface is adjacent to the second surface of the one or more filter media, wherein the second surface is the surface of the filter media which filtered feed passes from when in use.

11. A filter unit according to claim 1 wherein the baffle surface(s) cover no more than 90% of the axial length of the one or more filter media.

12. A filter unit according to claim 1 wherein the filter cage supports the one or more filter media so that it is retained in the shape of a frustrum of a cone, a cone, a pyramid, a prism, or a hemisphere.

13. A filter unit according to claim 1 wherein the pores in the one or more filter media have a mean pore size of from 1 to 100 microns.

14. A filter unit according to claim 1 wherein the filter unit comprises a pipe configured such that feed from the inlet passes through the interior of the filter cage through the pipe.

15. A filter unit according to claim 14 wherein the filter unit is configured so that feed exits from the pipe and passes through the exterior surface of the one or more filter media and exits the interior surface of the one or more filter media as a filtered liquid.

16. A filter unit according to claim 1 wherein the one or more filter media are in the form of a non-woven mesh, a woven mesh, a knitted mesh or a perforated sheet.

17. A filter unit according to claim 1 wherein the filter unit comprises one or more impeller(s) in the housing, and wherein the one or more impeller is upstream and/or downstream of the filter media.

18. A filter unit according to claim 1 wherein the housing comprises an opening and a moveable lid that is movable between a first configuration and a second configuration;
in the first configuration the moveable lid cooperates with the housing to seal the opening so entry of the effluent into the housing is through the inlet only, and exit of the filtered effluent from the housing is through the outlet only; and
in the second configuration the moveable lid has moved to expose the opening in the housing so that filtride accumulated on the filter media can be removed from the housing through the opening; and wherein the filter cage is rotatable to throw filtride from the filter media through the opening when the moveable lid is in the second configuration.

19. A filter unit according to claim 18, wherein the filter unit is configured to rotate the filter media via the drive means to throw filtride from the filter media.

20. A filter unit according to claim 18 wherein the filter unit comprises a container for receiving filtride that is external to the housing.

21. A filter unit according to claim 20, wherein the container is adjacent to and radially outwards of the opening from the axis of rotation when the moveable lid is in the second configuration.

22. A filter unit according to claim 18, wherein the moveable lid is shaped as a frustrum, a cone, a cylinder, or a pyramid.

23. A filter unit according to claim 18, wherein the moveable lid moves linearly between the first and second configurations; and optionally wherein the moveable lid moves linearly in the horizontal direction.

24. A textile treatment apparatus comprising a filter unit according to claim 1 where the filter unit is connected to the textile treatment apparatus to receive feed therefrom.

25. A textile treatment apparatus according to claim 24 which is a washing machine.

26. A method of filtering a feed comprising microfibres using a filter unit according to claim 1.

27. A method of filtering a feed comprising microparticles comprising:
i. providing a filter unit according to claim 18;
ii. placing the filter unit in the first configuration;
iii. supplying effluent from a textile treatment apparatus to the inlet of the filter unit;
iv. filtering the effluent through the filter medium and passing the filtered effluent to the outlet;
v. stopping the supply of effluent;
vi. placing the filter unit in the second configuration;
vii. rotating the filter cage to throw filter residue from the filter medium through the opening.

28. A method according to claim 27, further comprising the subsequent steps of:
vii. returning the filter unit to the first configuration;
ix. resuming supply and filtering of feed.

29. A method according to claim 26, wherein the feed is from a single treatment cycle of the textile treatment apparatus.

30. A method according to claim 26 wherein the feed comprising microfibres originates from a textile treatment apparatus.

31. A method according to claim 26 wherein during filtration the filter cage is rotated at a speed such that the internal surface of the one or more filter media experiences a G force of at least 20 G.

32. A method according to claim 26 wherein during filtration the turbulence at the outermost surface of the filter media corresponds to a Reynolds number of at least 3000.

33. A method according to claim 26 wherein the feed is passed through the filter unit only once.

34. A method according to claim 26 wherein the feed is passed through the filter unit multiple times.

35. A method according to claim 26 wherein the filter unit filters feed from at least 5 textile treatment cycles before requiring any cleaning.

36. A method according to claim 26 wherein the microfibres are or comprise a cellulosic material.

37. A method according to claim 26 wherein the microfibres have a longest linear dimension of less than 1 mm.

38. A method according to claim 26 wherein the efficiency of the filter unit at removing microfibres is at least 70% by mass relative to all the microfibres originally present in the feed.

39. A method according to claim 26 wherein the flow rate of the feed through the filter unit is at least 1 litre/minute.
